(19) United States
(12) Patent Application Publication
(10) Pub. No.: US 2010/0164654 A1
(43) Pub. Date: Jul. 1, 2010

(54) WAVEGUIDE STRUCTURE, ANTENNA APPARATUS THAT USES THAT WAVEGUIDE STRUCTURE, AND VEHICLE RADAR APPARATUS IN WHICH A WAVEGUIDE STRUCTURE OR AN ANTENNA APPARATUS IS USED

(75) Inventor: Yoshiyuki FUJII, Chiyoda-ku (JP)

Correspondence Address: SUGHRUE MION, PLLC, 2100 PENNSYLVANIA AVENUE, N.W., SUITE 800, WASHINGTON, DC, 20037, US

(73) Assignee: MITSUBISHI ELECTRIC CORPORATION, TOKYO (JP)

(21) Appl. No.: 12/473,865

(22) Filed: May 28, 2009

(30) Foreign Application Priority Data
Dec. 26, 2008 (JP) 2008-333863

(51) Int. Cl. H01P 3/12

(52) U.S. Cl. 333/248

(57) ABSTRACT

The present invention provides a waveguide structure that prevents occurrences of gaps that communicate between internal and external portions of a waveguide without increasing energy transmission loss of high frequency signals, that is low cost, that has superior durability, and that is compact.

The waveguide structure includes: a base that has a mounting surface; a metal plate member that has elasticity, that is stacked on the mounting surface, and that functions together with the base to constitute a waveguide; a positioning mechanism that is constituted by: a positioning pin that is disposed so as to protrude from the base; and an interfitting portion that is formed on the plate member, and that is fitted together with the positioning pin, the positioning mechanism positioning the plate member on the mounting surface of the base and also restricting movement along the mounting surface by fitting together of the positioning pin and the interfitting portion; and a holder that holds the plate member in a state of close contact with the mounting surface by pressing the plate member so as to generate a reaction force in the plate member.

### BACKGROUND OF THE INVENTION

1. Field of the Invention

The present invention relates to a waveguide structure that is particularly suitable for transmission of high frequency signals in a microwave band and a millimeter wave band, an antenna apparatus that uses that waveguide structure, and a vehicle radar apparatus in which a waveguide structure or an antenna apparatus is used.

2. Description of the Related Art

Conventional waveguide structures have: a metal first conductive member in which a first groove that has an opening on a flat surface is formed; and a metal second conductive member that is formed so as to have a flat plate shape, that is disposed on the surface of the first conductive member so as to cover the first groove of the first conductive member, and that is fastened to the first conductive member by screws, a waveguide being configured between the first groove of the first conductive member and the second conductive member.

However, when flat first and second conductive members are fastened using screws, the fastening forces from the screws do not act uniformly on the surfaces of the facing first and second conductive members. Thus, buckling may occur in the thin plate-shaped second conductive member, giving rise to gaps between the first and second conductive members that communicate between internal and external portions of the waveguide. In such cases, high frequency signals may leak out through the gaps between the first and second conductive members when propagating through the waveguide, giving rise to problems such as deterioration in energy transmission efficiency of the high frequency signals, etc.

When a plurality of waveguides are configured on the above waveguide structure, because it is necessary to fasten walls that partition off a plurality of first grooves that are formed on the first conductive member and the second conductive member using screws, the waveguides cannot be placed closer to each other than a diameter of the screws, giving rise to problems such as being unable to reduce the waveguide structure in size, etc. In other words, it may not be possible to adapt the above waveguide structures to waveguide structures for the transmission of high frequency signals in the microwave band and the millimeter wave band for which reductions in size are being demanded. Other problems also arise such as deterioration in isolation between the waveguides, etc.

As structures that suppress deterioration in isolation between the waveguides, or deterioration in energy transmission efficiency when the high frequency signals propagate through the waveguides, etc., that results from gaps that communicate between internal and external portions of the waveguides, there have been proposed:

conventional high frequency signal transmission casings in which waveguides are configured by joining together first and second conductive members by means of a conductive rubber material (see Patent Literature 1, for example);

first conventional waveguide slot array antennas in which waveguides are configured by joining together first and second conductive members by means of a conductive pressure sensitive adhesive sheet (see Patent Literature 2, for example); and

second conventional waveguide slot array antennas that fix first and second conductive members using an adhesive to configure waveguides, and that have bumps that are made of a conductive resin that are disposed in advance so as to penetrate that adhesive to ensure continuity between the first and second conductive members (see Patent Literature 3, for example).

In addition, there have been proposed:

conventional waveguide pipes in which waveguides are configured by joining together first and second conductive members by frictional stirring and bonding (see Patent Literature 4, for example); and

conventional waveguide converters that suppress leakage of high frequency signals from gaps that communicate between internal and external portions of waveguides between first and second conductive members, if such gaps arise, by forming a second groove that has a predetermined depth that has an opening on a surface of the first conductive member in close proximity to both sides of a first groove in a width direction (see Patent Literature 5, for example).
[Patent Literature 1]: Japanese Patent Laid-Open No. HEI 8-186401 (Gazette)
[Patent Literature 2]: Japanese Patent Laid-Open No. 2003-318641 (Gazette)
[Patent Literature 3]: Japanese Patent No. 3650083 (Gazette)
[Patent Literature 4]: Japanese Patent No. 3610274 (Gazette)
[Patent Literature 5]: Japanese Patent No. 3843946 (Gazette)

In conventional high frequency signal transmission casings, two waveguides are configured in a casing that has an opening on one surface by integrating a conductive rubber material between a bottom surface of a partitioning plate and the casing, fixing the partitioning plate and the conductive rubber material using screws, and fixing a conductive cover to an opening edge portion of the casing so as to cover two first grooves that are constituted by the partitioning plate and the casing. Here, because the conductive rubber material is elastically deformed by being pressed and held between the casing and the partitioning plate, it is placed in close contact with the partitioning plate and the casing, enabling gaps near the bottom of the first groove to be eliminated.

In conventional high frequency signal transmission casings, the conductive rubber material is interposed between the bottom surface of the partitioning plate and the casing, but eliminating gaps between the internal portion and the external portion of the waveguides of the waveguide structure by applying the conductive rubber material so as to be interposed between the first and second conductive members of the above waveguide structure is easily conceivable.

However, even if a conductive rubber material is interposed between the above first and second conductive members, when a plurality of waveguides are to be configured, it is necessary to fix the walls of the first conductive member that partition off the first grooves and the second conductive member using screws, and problems remain such as being unable to reduce the waveguide structure in size. In addition, because electroconductivity of the conductive rubber material is small compared to metal, energy transmission loss is increased when high frequency signals propagate through waveguides in a waveguide structure to which the conductive rubber material has been applied compared to when the waveguides are configured using only metal.

Because volume of the conductive rubber material reduces as it deteriorates with the passage of time, gaps may arise that communicate between internal and external portions of the waveguides as time passes. It is also commonly known that the rate of temperature change in the electroconductivity of a conductive rubber material is high. In other words, another problem has been that optimal waveguide conditions for efficiently propagating high frequency signals cannot be maintained against the passage of time and temperature changes in a waveguide structure to which conductive rubber has been applied.

First conventional waveguide slot array antennas have a construction in which a conductive slot plate and base body that constitute a waveguide are joined together using a conductive pressure sensitive adhesive sheet. Because the slot plate and the base body are thereby placed in close contact with the conductive pressure sensitive adhesive sheet, gaps that communicate between internal and external portions of the waveguide can also be eliminated.

However, conductive pressure sensitive adhesive sheets have characteristics are such that not only is their electroconductivity small compared to the electroconductivity of metal, their rate of temperature change is high, and their volume reduces as they deteriorate with the passage of time. Consequently, although reductions in size are enabled because first conventional waveguide slot array antennas perform joining together of the slot plate and the base body by adhesion of the conductive pressure sensitive adhesive sheet without using screws, with regard to other points they have similar problems to waveguide structures to which the conductive rubber material has been applied.

Second conventional waveguide slot array antennas have a construction in which a slot plate and a base body that are made of metal that constitute waveguides are joined together by an adhesive, and bumps that are constituted by a conductive resin that are disposed in advance on adhesive positions of the slot plate pass through the adhesive to contact and communicate with the base body. Gaps that communicate between internal and external portions of the waveguide can thereby also be eliminated.

Because second conventional waveguide slot array antennas perform joining together of the slot plate and the base body using an adhesive without using screws, reductions in size are enabled. If a predetermined adhesive is selected, the degree of degradation of the adhesive as time passes can also be reduced compared to the conductive rubber material and the conductive sheet.

However, because continuity between the slot plate and the base body is performed only by the bumps, one problem has been that electrical continuity between the slot plate and the base body is insufficient, increasing energy transmission loss when high frequency signals propagate through the waveguides.

Because conductive members of conventional waveguide pipes are joined together by frictional stirring and bonding, the conductive members are joined together without gaps, enabling increases in energy transmission loss when high frequency signals propagate through the wave guides to be suppressed. However, joining together of the conductive members by frictional stirring and bonding is performed beyond the joined portion between the conductive members. Consequently, problems remain such as conventional waveguide pipes not being able to respond to demands for reductions in size.

In conventional waveguide converters, because space for the second grooves that are formed on two sides in the width direction of the first groove must be ensured on the first conductive member, problems remain such as not being able to respond to demands for reductions in size. Even if the conventional waveguide converters could hypothetically be reduced in size by forming the second grooves on the first conductive member accurately with an extremely small width, new problems arise such as increased costs related to forming the second grooves.

### SUMMARY OF THE INVENTION

The present invention aims to solve the above problems and an object of the present invention is to provide a waveguide structure that prevents occurrences of gaps that communicate between internal and external portions of a waveguide without increasing energy transmission loss of high frequency signals, that is low cost, that has superior durability, and that is compact, an antenna apparatus that uses that waveguide structure, and a vehicle radar apparatus in which a waveguide structure or an antenna apparatus is used.

In order to achieve the above object, according to one aspect of the present invention, there is provided a waveguide structure including: a base that has a mounting surface; a metal plate member that has elasticity, that is stacked on the mounting surface, and that functions together with the base to constitute a waveguide. The waveguide structure includes a positioning mechanism that is constituted by: a positioning member that is disposed so as to protrude from a first of the base and the plate member; and an interfitting portion that is formed on a second of the base and the plate member, and that is fitted together with the positioning member, the positioning mechanism positioning the plate member on the mounting surface of the base and also restricting movement along the mounting surface by fitting together of the positioning member and the interfitting portion. The waveguide structure includes a holding means that holds the plate member in a state of close contact with the mounting surface by pressing the plate member so as to generate a reaction force in the plate member.

According to the waveguide structure of the present invention, a metal plate member can be held in a state of close contact on a mounting surface that in configured on a metal base, and that is obtained by sweeping in a sweep direction a deflection curve for a beam supported at two ends so as to generate a reaction force in the plate member. Thus, the waveguide structure can be configured while preventing occurrences of gaps that communicate between internal and external portions of the waveguide without using members that have inferior electroconductivity to metal, and without directly fastening portions of the mounting surface and the plate member that face each other using screws. Together with this, it is no longer necessary to form a groove for suppressing leakage of high frequency signals on the base of the waveguide structure in the manner of conventional waveguide converters. Consequently, the waveguide structure can suppress increases in energy transmission loss of high frequency signals while also ensuring durability at reduced cost, and also makes it possible to respond to demand for reductions in size.

### BRIEF DESCRIPTION OF THE DRAWINGS

FIG. 1 is a perspective of a waveguide structure according to Embodiment 1 of the present invention;

FIG. 2 is an exploded perspective of the waveguide structure according to Embodiment 1 of the present invention;

FIG. 3 is a cross section taken along Line III-III in FIG. 1 viewed from the direction of the arrows;

FIG. 4 is a cross section taken along Line IV-IV in FIG. 3 viewed from the direction of the arrows;

FIG. 5 is a diagram for explaining a procedure for assembling the waveguide structure of the invention according to Embodiment 1 of the present invention;

FIG. 6 is an exploded perspective that shows another variation of the waveguide structure according to Embodiment 1 of the present invention, and shows a case in which the waveguide structure has two wave guides;

FIG. 7 is an exploded perspective of a waveguide structure according to a first preferred variation of the present invention;

FIG. 8 is an exploded perspective of a waveguide structure according to a second preferred variation of the present invention;

FIG. 9 is a perspective of a waveguide structure according to a third preferred variation of the present invention;

FIG. 10 is an exploded perspective of the waveguide structure according to the third preferred variation of the present invention;

FIG. 11 is a perspective of a waveguide structure according to Embodiment 2 of the present invention;

FIG. 12 is an exploded perspective of the waveguide structure according to Embodiment 2 of the present invention;

FIGS. 13A and 13B are partial front elevations of other variations of the waveguide structure according to Embodiment 2 of the present invention;

FIG. 14 is a perspective of a waveguide structure according to Embodiment 3 of the present invention;

FIG. 15 is an exploded perspective of the waveguide structure according to Embodiment 3 of the present invention;

FIG. 16 is a perspective of another variation of the waveguide structure according to Embodiment 3 of the present invention;

FIG. 17 is an exploded perspective of the other variation of the wave guide structure according to Embodiment 3 of the present invention;

FIG. 18 is a perspective of a waveguide structure according to Embodiment 4 of the present invention;

FIG. 19 is an exploded perspective of the waveguide structure according to Embodiment 4 of the present invention;

FIG. 20 is a perspective of a waveguide structure according to Embodiment 5 of the present invention;

FIG. 21 is an exploded perspective of the waveguide structure according to Embodiment 5 of the present invention;

FIG. 22 is a perspective of another variation of the waveguide structure according to Embodiment 5 of the present invention;

FIG. 23 is an exploded perspective of the other variation of the wave guide structure according to Embodiment 5 of the present invention;

FIG. 24 is a perspective of yet another variation of the waveguide structure according to Embodiment 5 of the present invention;

FIG. 25 is an exploded perspective of that other variation of the wave guide structure according to Embodiment 5 of the present invention;

FIG. 26 is a perspective of a waveguide structure according to Embodiment 6 of the present invention;

FIG. 27 is an exploded perspective of the waveguide structure according to Embodiment 6 of the present invention;

FIG. 28 is a perspective of a waveguide structure according to Embodiment 7 of the present invention;

FIG. 29 is an exploded perspective of the waveguide structure according to Embodiment 7 of the present invention;

FIG. 30 is a perspective of a waveguide structure according to Embodiment 8 of the present invention;

FIG. 31 is an exploded perspective of the waveguide structure according to Embodiment 8 of the present invention;

FIG. 32 is an enlarged front elevation of Portion C in FIG. 30;

FIG. 33 is a front elevation that does not consider a second plate member from FIG. 32;

FIG. 34 is a perspective of a waveguide structure according to Embodiment 9 of the present invention;

FIG. 35 is an exploded perspective of the waveguide structure according to Embodiment 9 of the present invention;

FIG. 36 is a cross section taken along Line XXXVI-XXXVI in FIG. 34 viewed from the direction of the arrows;

FIG. 37 is a cross section taken along Line XXXVII-XXXVII in FIG. 36 viewed from the direction of the arrows;

FIG. 38 is a diagram for explaining a procedure for assembling the waveguide structure of the invention according to Embodiment 9 of the present invention;

FIG. 39 is a perspective of a waveguide structure according to Embodiment 10 of the present invention;

FIG. 40 is an exploded perspective of the waveguide structure according to Embodiment 10 of the present invention;

FIG. 41 is a cross section taken along Line XLI-XLI in FIG. 39 viewed from the direction of the arrows;

FIG. 42 is a cross section taken along Line XLII-XLII in FIG. 41 viewed from the direction of the arrows;

FIG. 43 is a diagram for explaining a procedure for assembling the waveguide structure of the invention according to Embodiment 10 of the present invention;

FIG. 44 is a perspective of a waveguide structure according to Embodiment 11 of the present invention;

FIG. 45 is an exploded perspective of the waveguide structure according to Embodiment 11 of the present invention; and

FIG. 46 is a perspective of a slot array antenna according to Embodiment 12 of the present invention.

### DETAILED DESCRIPTION OF THE PREFERRED EMBODIMENTS

Preferred embodiments of the present invention will now be explained with reference to the drawings.

### Embodiment 1

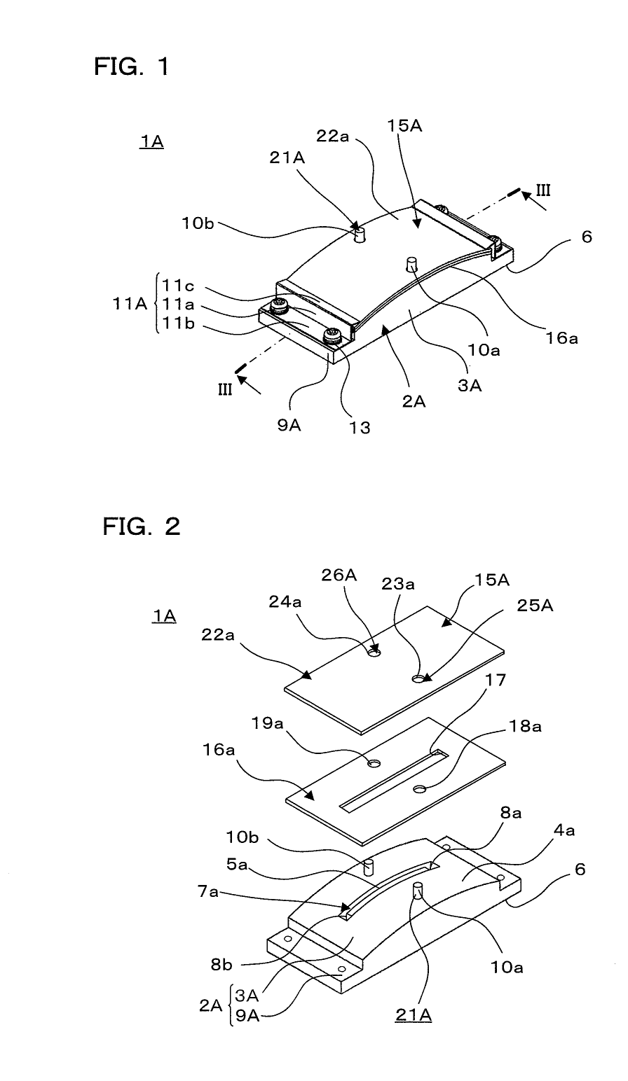

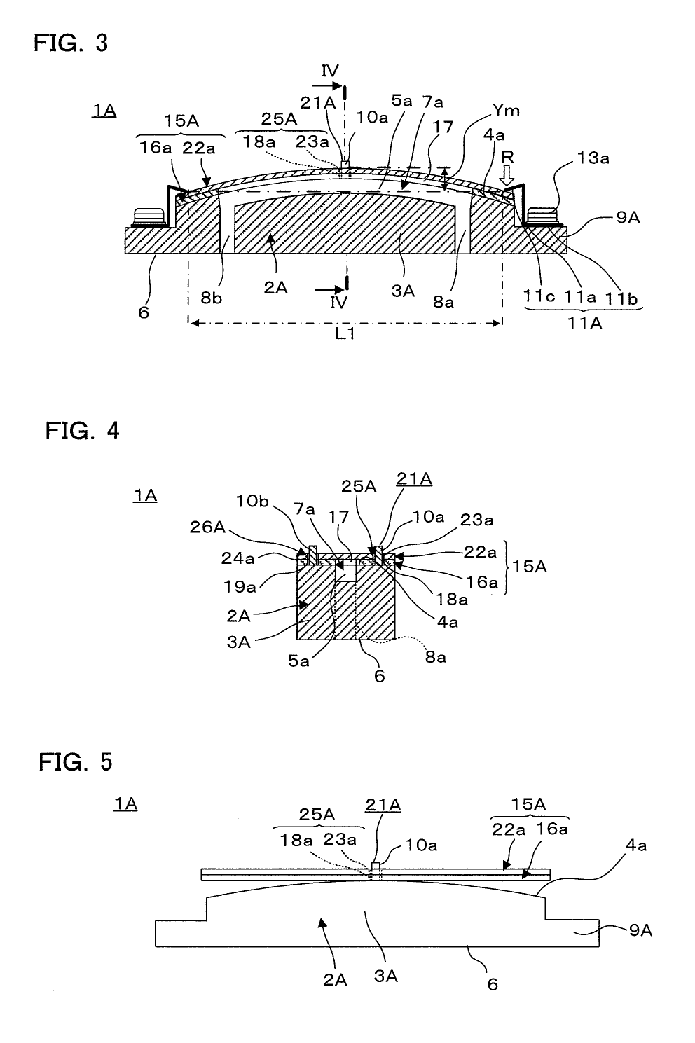

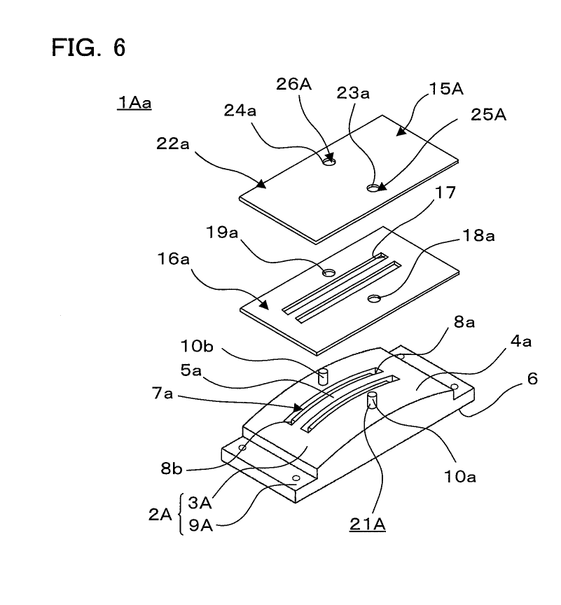

FIG. 1 is a perspective of a waveguide structure according to Embodiment 1 of the present invention, FIG. 2 is an exploded perspective of the waveguide structure according to Embodiment 1 of the present invention, FIG. 3 is a cross section taken along Line III-III in FIG. 1 viewed from the direction of the arrows, FIG. 4 is a cross section taken along Line IV-IV in FIG. 3 viewed from the direction of the arrows, FIG. 5 is a diagram for explaining a procedure for assembling the waveguide structure of the invention according to Embodiment 1 of the present invention, and FIG. 6 is an exploded perspective that shows another variation of the waveguide structure according to Embodiment 1 of the present invention, and shows a case in which the waveguide structure has two waveguides.

Moreover, depiction of holders is omitted in FIG. 2.

In FIGS. 1 through 4, a waveguide structure 1A includes: a metal base 2A that has a curved mounting surface 4a; and an elastic metal plate member 15A that is stacked on the mounting surface 4a and that functions together with the base 2A to constitute a waveguide 7a. In addition, the waveguide structure 1A includes: a positioning mechanism 21A that is constituted by: a first positioning pin 10a and a second positioning pin 10b that function as a positioning member that is disposed so as to protrude from the mounting surface 4a; and a first interfitting portion 25A and a second interfitting portion 26A that are formed on the plate member 15A and that are fitted together with the first positioning pin 10a and the second positioning pin 10b, the positioning mechanism 21A positioning the plate member 15A on the mounting surface 4a of the base 2A, and also restricting movement parallel to the mounting surface 4a; and a holder 11A that functions as a holding means that holds the plate member 15A on the mounting surface 4a in a state of close contact.

The base 2A includes: a main body portion 3A that is rectangular when viewed from a side that is opposite the mounting surface 4a; and flanges 9A that extend outward from two longitudinal ends of the main body portion 3A.

Hereinafter, a longitudinal direction when the main body portion 3A is viewed from the side that is opposite the mounting surface 4a will simply be called the longitudinal direction of the main body portion 3A.

The mounting surface 4a is configured so as to have a convex curved surface that is obtained by sweeping in a sweep direction a deflection curve for a beam that is supported at two ends. Moreover, the sweep direction is a direction that is perpendicular to a plane that includes the deflection curve.

The deflection curve for a beam that is supported at two ends is set as follows:

two longitudinal edge portions of the plate member 15A are supported and the plate member 15A is deflected by applying a load between the two longitudinal edge portions. The deflection curve for a beam that is supported at two ends is set so as to be a curve that is parallel to major surfaces (front and rear surfaces) of the plate member 15A in a cross section that is perpendicular to the width direction of the plate member 15A in this state. Moreover, if it is necessary to make the pressure distribution between the plate member 15A and the base 2A uniform when the plate member 15A is deflected parallel to the mounting surface 4a by pressing two longitudinal edges of the plate member 15A, it is desirable for the deflection curve for a beam that is supported at two ends to be a shape that applies a uniformly distributed load over an entire region in the longitudinal direction of the plate member 15A.

Hereinafter, the direction that follows the mounting surface 4a in the cross section of the main body portion 3A that is perpendicular to the sweep direction, which does not have a curvature, will be called “the curve direction”.

The mounting surface 4a is formed so as to have a curve in the cross section of the main body portion 3A that is perpendicular to the sweep direction in which a distance from a line segment that connects two ends of the mounting surface 4a increases toward center in the curve direction, as shown in FIG. 3. In other words, the distance from a plane that includes the two edge portions of the mounting surface 4a in the curve direction increases toward a longitudinal center in the curve direction of the mounting surface 4a. Hereinafter, the portion of the mounting surface 4a at which the distance from the plane that includes the two edge portions of the mounting surface 4a in the curve direction is greatest will be called “a mounting surface maximum projecting portion”.

A flat input and output port forming surface 6 is configured on a surface on an opposite side of the base 2A from the mounting surface 4a.

A waveguide groove 5a that has an opening on the mounting surface 4a is formed on the main body portion 3A. Here, the waveguide groove 5a extends for a predetermined length in the curve direction of the mounting surface 4a at a predetermined width in the sweep direction of the mounting surface 4a. A bottom surface of the waveguide groove 5a is configured so as to have a curved surface that has a curvature that matches the curvature of the mounting surface 4a in the curve direction.

Waveguide input and output passages 8a and 8b are formed on the main body portion 3A so as to pass through between two ends of the waveguide groove 5a and the input and output port forming surface 6.

The first positioning pin 10a and the second positioning pin 10b, which are both cylindrical, are disposed so as to protrude at the mounting surface maximum projecting portion on two sides of the waveguide groove 5a in the sweep direction.

Here, the first positioning pin 10a and the second positioning pin 10b are each separated by a first distance from two edge portions parallel to the curve direction of the mounting surface 4a (two edge portions in the sweep direction), respectively.

The plate member 15A is constituted by a two-layer divided plate member that is made up of: a first divided plate member 16a that is stacked on the mounting surface 4a; and a second divided plate member 22a that is stacked on the first divided plate member 16a. The first divided plate member 16a and the second divided plate member 22a are constituted by similar elastic metals.

The first divided plate member 16a is configured so as to have a flat, rectangular shape that has long sides that match a length of the mounting surface 4a in the curve direction, and short sides that match a length of the mounting surface 4a in the sweep direction. A waveguide constituting aperture 17 that has a width and a length that match a width and a length of the waveguide groove 5a is formed on the first divided plate member 16a so as to face the waveguide groove 5a when the first divided plate member 16a and the mounting surface 4a are placed in close contact with outer edges aligned.

In addition, a first interfitting aperture 18a and a second interfitting aperture 19a that have an aperture shape that is circular are respectively formed on portions of the first divided plate member 16a that are central in the longitudinal direction, and that are separated by a first distance from each of the two long sides.

The second divided plate member 22a is configured so as to have a flat, rectangular shape that is identical in size to the first divided plate member 16a. In addition, a third interfitting aperture 23a and a fourth interfitting aperture 24a that have aperture shapes that are similar to those of the first interfitting aperture 18a and the second interfitting aperture 19a are respectively formed on portions of the second divided plate member 22a that are central in the longitudinal direction, and that are separated by a first distance from each of the two long sides.

The first divided plate member 16a is stacked on the mounting surface 4a such that a first surface thereof faces the mounting surface 4a in a state in which the first positioning pin 10a and the second positioning pin 10b are inserted through (fitted together with) the first interfitting aperture 18a and the second interfitting aperture 19a.

In addition, the second divided plate member 22a is stacked on the first divided plate member 16a such that a first surface thereof faces a second surface of the first divided plate member 16a in a state in which the first positioning pin 10a and the second positioning pin 10b are inserted through the third interfitting aperture 23a and the fourth interfitting aperture 24a.

The positioning mechanism 21A is constituted by the first positioning pin 10a, the second positioning pin 10b, the first interfitting portion 25A, which is constituted by the first interfitting aperture 18a and the third interfitting aperture 23a, and the second interfitting portion 26A, which is constituted by the second interfitting aperture 19a and the fourth interfitting aperture 24a. Here, external shapes of the first positioning pin 10a and the second positioning pin 10b approximately match internal shapes of each of the interfitting apertures. In other words, the positioning mechanism 21A positions the plate member 15A at a prescribed position on the mounting surface 4a and also restricts movement of the plate member 15A parallel to the mounting surface 4a by the fitting together of the first positioning pin 10a and the first interfitting portion 25A, and by the fitting together of the second positioning pin 10b and the second interfitting portion 26A.

Two curve direction edge portions of the second divided plate member 22a are pressed by a pair of holders 11A that will be explained below such that the first divided plate member 16a and the second divided plate member 22a extend parallel to the curved shape of the mounting surface 4a in an elastically deformed state.

Here, the “two curve direction edge portions” means predetermined portions in a range that includes a vicinity of the two edge portions of the second divided plate member 22a that are parallel to the sweep direction.

The holders 11A are configured by bending two long side portions of flat, rectangular leaf springs in opposing directions. Specifically, the holders 11A are constituted by: an intermediate portion 11a; and a mounted portion 11b and a pressing portion 11c that extend outward from the intermediate portion 11a in opposite directions. Here, the mounted portion 11b extends outward so as to be perpendicular to the intermediate portion 11a, and the pressing portion 11c extends outward at an acute angle relative to the intermediate portion 11a.

The mounted portion 11b of a first holder 11A is securely fastened onto a first flange 9A by screws 13. Here, the intermediate portion 11a of the holder 11A extends so as to project beyond the mounting surface 4a opposite a first side surface that is perpendicular to the longitudinal direction of the main body portion 3A. A leading end of the pressing portion 11c is placed in contact over an entire region in the sweep direction with a vicinity of a first curve direction edge portion of the second divided plate member 22a that is curved parallel to the mounting surface 4a, and the pressing portion 11c presses the second divided plate member 22a.

The mounted portion 11b of a second holder 11A is securely fastened onto a second flange 9A by screws 13. Here, the intermediate portion 11a of the second holder 11A extends so as to project beyond the mounting surface 4a opposite a second side surface that is perpendicular to the longitudinal direction of the main body portion 3A. A leading end of the pressing portion 11c is placed in contact over an entire region in the sweep direction with a vicinity of a second curve direction edge portion of the second divided plate member 22a that is curved parallel to the mounting surface 4a, and the pressing portion 11c presses the second divided plate member 22a.

The first divided plate member 16a and the second divided plate member 22a are held stably on the mounting surface 4a in a curved state parallel to the mounting surface 4a by pressing forces from the holders 11A.

The waveguide groove 5a, the waveguide constituting aperture 17, and the second divided plate member 22a function together to constitute a waveguide 7a that extends in the longitudinal direction of the main body portion 3A.

The shape of the deflection curve of the mounting surface 4a, in other words, the shape of the curve due to the path that is drawn in the curve direction of the mounting surface 4a, is configured so as to satisfy Expression (1) below, and the holders 11A are configured so as to press the predetermined positions in the vicinity of the two curve direction ends of the second divided plate member 22a with a pressing force R that can be expressed by Expression (2) below.

Moreover, Expression (1) is a deflection curve formula from material mechanics for a beam supported at two ends that is subjected to a uniformly distributed load along its entire length, and Expression (2) is an expression that is easily found from a maximum deflection formula and a geometrical-moment of inertia formula for a plate.

Y=16YmX(X3−2L1X2+L13)/(5L14) (1)

R=192kEbh3Ym/(60L13) (2)

Here, a Y-axis direction is a normal direction of a plane that includes the edge portions of the mounting surface 4a at the two ends in the curve direction, and an X-axis direction is a direction in which the edge portions of the mounting surface 4a at the two ends in the curve direction face each other. Point 0 of the Y-axis is a contacting portion between the holders 11A and the second divided plate member 22a, and Point 0 of the X-axis is a contacting portion between the first holder 11A and the second divided plate member 22a.

Ym, L1, E, b, h, and k are defined as follows:

Ym is maximum deflection of the second divided plate member 22a, which is defined by a maximum distance from a plane that includes two straight lines that are constituted by the contacting portions between the holders 11A and the second divided plate member 22a to a front surface (a second surface) of the second divided plate member 22a;

L1 is a distance between two contact positions between the pair of holders 11A and the second divided plate member 22a;

E is a modulus of longitudinal elasticity of the first divided plate member 16a and the second divided plate member 22a

b is a length of the first divided plate member 16a and the second divided plate member 22a in the sweep direction;

h is a total thickness of the first divided plate member 16a and the second divided plate member 22a; and

k is the number of divided plate members that constitute the plate member 15A.

When the first divided plate member 16a and the second divided plate member 22a are curved parallel to a mounting surface 4a that is configured into a curved surface that has a cross section perpendicular to the sweep direction that satisfies Expression (1) and the two edge portions in the curve direction of the first divided plate member 16a and the second divided plate member 22a are pressed with a pressing force that has a predetermined value R that is defined by Expression (2), reaction forces arise in the first divided plate member 16a and the second divided plate member 22a that act in a direction in which an entire region of the first divided plate member 16a and the second divided plate member 22a are pressed against the mounting surface 4a.

In other words, the first divided plate member 16a is stacked onto the mounting surface 4a without forming gaps between it and the mounting surface 4a, and the second divided plate member 22a is stacked onto the first divided plate member 16a without forming gaps between it and the first divided plate member 16a.

Stable electrical continuity is thereby ensured between the first divided plate member 16a and the main body portion 3A, and between the first divided plate member 16a and the second divided plate member 22a.

Next, a procedure for assembling the waveguide structure 1A will be explained.

First, the first divided plate member 16a is disposed on the mounting surface 4a by inserting the first positioning pin 10a and the second positioning pin 10b through the first interfitting aperture 18a and the second interfitting aperture 19a of the first divided plate member 16a, as shown in FIG. 5. Next, the second divided plate member 22a is disposed on the first divided plate member 16a by inserting the first positioning pin 10a and the second positioning pin 10b through the third interfitting aperture 23a and the fourth interfitting aperture 24a of the second divided plate member 22a.

The first divided plate member 16a and the second divided plate member 22a are deformed elastically from near the first positioning pin 10a and the second positioning pin 10b toward a first end of the mounting surface 4a in the curve direction so as to lie parallel to the mounting surface 4a. Next, while maintaining elastic deformation, the first holder 11A is fixed by fastening the first flange 9A and the mounted portion 11b using screws 13 such that a leading end of the first divided plate member 16a near the pressing portion 11c of the holder 11A is placed in contact with a vicinity of the short sides of the second divided plate member 22a over an entire region in the width direction.

Next, the first divided plate member 16a and the second divided plate member 22a are deformed elastically from near the first positioning pin 10a and the second positioning pin 10b toward a second end of the mounting surface 4a in the curve direction so as to lie parallel to the mounting surface 4a. Next, assembly of the waveguide structure 1A that is shown in FIGS. 1, 3, and 4 is completed by fastening the second holder 11A onto the second flange 9A while maintaining elastic deformation.

The waveguide structure 1A according to Embodiment 1 includes: a metal base 2A that has a mounting surface 4a that is configured so as to have a curved surface that is obtained by sweeping in a sweep direction a deflection curve for a beam supported at two ends; and an elastic metal plate member 15A that is stacked on the mounting surface 4a and that functions together with the base 2A to constitute a waveguide 7a. In addition, the waveguide structure 1A includes holders 11A that press two curve direction edge portions of the plate member 15A that has been stacked on the mounting surface 4a so as to generate reaction forces in the respective first divided plate member 16a and second divided plate member 22a that constitute the plate member 15A to hold the first divided plate member 16a on the mounting surface 4a and the second divided plate member 22a on the first divided plate member 16a in a state of close contact.

Consequently, in the waveguide structure 1A, a first surface of the first divided plate member 16a and the mounting surface 4a, and a first surface of the second divided plate member 22a and a second surface of the first divided plate member 16a can be placed in close contact without using conductive rubber materials or adhesive sheets, etc., that have inferior electroconductivity to metal, and that deteriorate easily.

In other words, because the waveguide structure 1A can prevent gaps that communicate between internal and external portions of the waveguides 7a from forming without using a member that has inferior electroconductivity to metal, durability can be ensured while suppressing increases in energy transmission loss of high frequency signals.

One waveguide 7a is explained as being configured on the waveguide structure 1A, but the above effects can also be achieved even if the waveguide structure 1Aa is configured so as to have two adjacent waveguides 7a, as shown in FIG. 6, for example. Moreover, except for two waveguides 7a being formed, the configuration of the waveguide structure 1Aa is identical to that of the waveguide structure 1A. In other words, the first surface of the first divided plate member 16a is pressed onto the mounting surface 4a, and the first surface of the second divided plate member 22a is pressed onto the second surface of the first divided plate member 16a by a uniformly distributed load due to the reaction forces from the first divided plate member 16a and from the second divided plate member 22a even if a plurality of waveguides 7a are configured on the waveguide structure 1Aa. For this reason, because gaps that communicates between internal and external portions of the waveguides 7a are no longer formed even if the walls that partition off the waveguides 7a and the plate member 15A are not fastened together by screws, the waveguides 7a can be placed closer together and the waveguide structure configured more compactly. Consequently, it is possible to use the waveguide structure 1Aa as a waveguide structure for the transmission of high frequency signals in the microwave band and the millimeter wave band for which reductions in size are being demanded.

In addition, because it is also not necessary to form a groove for suppressing leakage of high frequency signals on two sides of the waveguide groove 5a, the waveguide structure 1A can be configured at reduced cost.

The waveguide structure 1A also includes: a positioning mechanism 21A that has: a first positioning pin 10a and a second positioning pin 10b that are disposed so as to project on a mounting surface maximum projecting portion so as to be separated in a sweep direction; and a first interfitting portion 25A and a second interfitting portion 26A that are formed on a plate member 15A and together with which the first positioning pin 10a and the second positioning pin 10b are fitted.

The internal shape of the first interfitting portion 25A approximately matches the external shape of the first positioning pin 10a, and the internal shape of the second interfitting portion 26A approximately matches the external shape of the second positioning pin 10b.

Consequently, movement of the first divided plate member 16a and the second divided plate member 22a parallel to the mounting surface 4a can be restricted by the first positioning pin 10a and the second positioning pin 10b, and the first divided plate member 16a and the second divided plate member 22a can be disposed accurately at the prescribed position on the mounting surface 4a simply by inserting the first positioning pin 10a and the second positioning pin 10b through each of the interfitting apertures that constitute the first interfitting portion 25A and the second interfitting portion 26A when the first divided plate member 16a and the second divided plate member 22a are stacked on the mounting surface 4a. In other words, the waveguide 7a can be configured to exact design dimensions.

The work of elastically deforming the first divided plate member 16a and the second divided plate member 22a over the mounting surface 4a is thereby facilitated. Consequently, workers who perform the curving work on the first divided plate member 16a and the second divided plate member 22a can be prevented from generating gaps that communicate between internal and external portions of the waveguide 7a by erroneously deforming the first divided plate member 16a and the second divided plate member 22a plastically, etc.

Moreover, it is necessary to increase milling precision of each of the positioning pins and each of the interfitting apertures in order to insert the first positioning pin 10a and the second positioning pin 10b through the first interfitting portion 25A and the second interfitting portion 26A practically without leaving gaps, but formation of each of the positioning pins and each of the interfitting apertures is easier than accurately forming a groove for suppressing leakage of high frequency signals on two sides of a waveguide groove 5a.

In addition, the positioning mechanism 21A is disposed so as to be aligned with a portion of the mounting surface 4a at which a distance from a plane that includes the two edge portions of the mounting surface 4a in the curve direction is at a maximum (the mounting surface maximum projecting portion). Wobbling of the first divided plate member 16a and the second divided plate member 22a that arises as a result of clearance between the first interfitting aperture 18a and the first positioning pin 10a and between the third interfitting aperture 23a and the first positioning pin 10a, and clearance between the second interfitting aperture 19a and the second positioning pin 10b, and between the fourth interfitting aperture 24a and the second positioning pin 10b, can be suppressed while curving the first divided plate member 16a and the second divided plate member 22a by elastically deforming the first divided plate member 16a and the second divided plate member 22a so as to cover the mounting surface maximum projecting portion when the first divided plate member 16a and the second divided plate member 22a are being curved. Thus, because the curving work on the first divided plate member 16a and the second divided plate member 22a is greatly facilitated, and the amount of time required for assembly of the waveguide structure 1A is shortened, costs of the waveguide structure 1A can also be reduced with regard to assembly.

The first positioning pin 10a and the second positioning pin 10b is explained as being cylindrical. However, the external shape of the positioning pins is not limited to being circular, and may also be a triangular prism, rectangular prism, or a any prismatic body that has an external shape other than circular, such as semicircular, etc. In that case, the first interfitting aperture, the second interfitting aperture, the third interfitting aperture, and the fourth interfitting aperture should also be configured so as to have internal shapes that match the external shapes of the positioning pins.

The positioning pins 10a and 10b are explained as being disposed on the mounting surface 4a as a pair, but are not limited to being disposed as a pair, and may also be replaced by a single positioning pin. In that case, if a positioning pin that has an external shape other than circular is used, a positioning mechanism may also be constituted by: a single positioning pin that is disposed on the mounting surface 4a; and interfitting apertures that are formed on the first divided plate member 16a and the second divided plate member 22a so as to have an internal shape that matches the external shape of the positioning pin.

The plate member 15A is explained as being constituted by a two-layer divided plate member that is constituted by the first divided plate member 16a and the second divided plate member 22a. However, the plate member 15A may also be constituted by a divided plate member that has three or more layers by stacking additional divided plate members that are similar to the first divided plate member 16a between the second divided plate member 22a and the mounting surface 4a, etc., or the plate member 15A may be constituted by only the second divided plate member 22a.

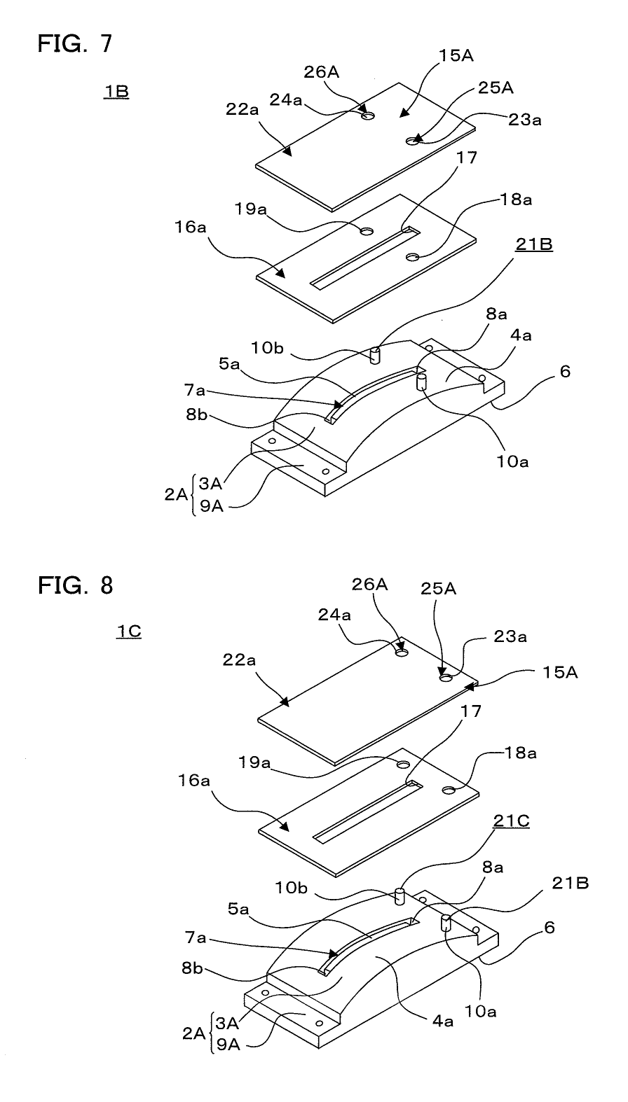

In Embodiment 1 above, the first positioning pin 10a and the second positioning pin 10b are explained as being disposed so as to be separated from each other so as to protrude from the mounting surface maximum projecting portion of the mounting surface 4a, but if the first positioning pin 10a and the second positioning pin 10b cannot be disposed so as to protrude from the mounting surface maximum projecting portion, they may be disposed so as to protrude from the mounting surface 4a in a similar manner to a first preferred variation that is shown in FIG. 7 or a second preferred variation that is shown in FIG. 8 below.

### First Preferred Variation

FIG. 7 is an exploded perspective of a waveguide structure according to a first preferred variation of the present invention.

In FIG. 7, a positioning mechanism 21B of a waveguide structure 1B has a configuration that is similar to that of the positioning mechanism 21A, but is configured so as to be aligned with a portion of the mounting surface 4a at which a gradient is gentlest. The rest of the configuration of the waveguide structure 1B is similar to that of the waveguide structure 1A.

A procedure for assembling the waveguide structure 1B is similar to the procedure for assembling the waveguide structure 1A.

Because the positioning mechanism 21B is configured so as to be aligned with a portion of the mounting surface 4a at which the gradient is gentlest, warping of the opening shapes of the first interfitting aperture 18a, the second interfitting aperture 19a, the third interfitting aperture 23a, and the fourth interfitting aperture 24a is also reduced when the first divided plate member 16a and the second divided plate member 22a are curved from a flat state during assembly of the waveguide structure 1B. In other words, because clearance of the diameters of the first interfitting aperture 18a and the third interfitting aperture 23a, and the second interfitting aperture 19a and the fourth interfitting aperture 24a, relative to the diameters of the first positioning pin 10a and the second positioning pin 10b can be reduced, positioning precision of the first divided plate member 16a and the second divided plate member 22a on the mounting surface 4a can be improved greatly.

### Second Preferred Variation

FIG. 8 is an exploded perspective of a waveguide structure according to a second preferred variation of the present invention.

In FIG. 8, a positioning mechanism 21C of a waveguide structure 1C has a configuration that is similar to that of the positioning mechanism 21A, but is configured on a portion of the mounting surface 4a near a first edge portion in the curve direction. The rest of the configuration of the wave guide structure 1C is similar to that of the waveguide structure 1A.

According to the waveguide structure 1C, movement of the first divided plate member 16a and the second divided plate member 22a parallel to the mounting surface 4a during assembly can be reliably restricted by first supporting first longitudinal end portions of the first divided plate member 16a and the second divided plate member 22a using a holder 11A. Consequently, the first divided plate member 16a and the second divided plate member 22a can be deformed elastically without having to be concerned about misalignments between the members due to wobbling of the first divided plate member 16a and the second divided plate member 22a that arises as a result of clearance between the first interfitting aperture 18a and the first positioning pin 10a and between the third interfitting aperture 23a and the first positioning pin 10a, and clearance between the second interfitting aperture 19a and the second positioning pin 10b, and between the fourth interfitting aperture 24a and the second positioning pin 10b, when the first divided plate member 16a and the second divided plate member 22a are being curved. Thus, costs of the waveguide structure 1C can also be reduced with regard to assembly.

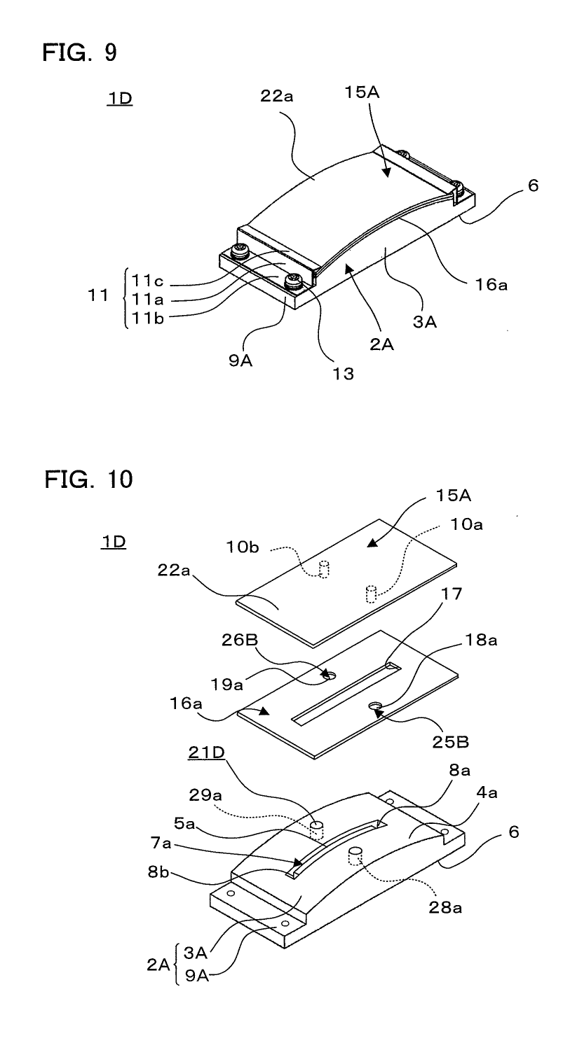

In the waveguide structures 1A through 1C, a first positioning pin 10a and a second positioning pin 10b are explained as being disposed so as to project from a mounting surface 4a of a base 2A, and a first interfitting portion 25A and a second interfitting portion 26A that fit together with the first positioning pin 10a and the second positioning pin 10b are formed on a plate member 15A. However, as described in the Third Preferred Variation, which will be explained below using FIGS. 9 and 10, a waveguide structure 1D may also be configured such that a first positioning pin 10a and a second positioning pin 10b are disposed so as to protrude from a second divided plate member 22a, and an first interfitting portion 25B and a second interfitting portion 26B that fit together with the first positioning pin 10a and the second positioning pin 10b are formed on a base 2A and a first divided plate member 16a.

### Third Preferred Variation

FIG. 9 is a perspective of a waveguide structure according to a third preferred variation of the present invention, and FIG. 10 is an exploded perspective of the waveguide structure according to the third preferred variation of the present invention.

In FIGS. 9 and 10, a waveguide structure 1D is similar to the waveguide structure 1A except that a fifth interfitting aperture 28a and a sixth interfitting aperture 29a are formed to a predetermined depth on the main body portion 3A instead of the third interfitting aperture 23a and the fourth interfitting aperture 24a of the second divided plate member 22a, and a first positioning pin 10a and a second positioning pin 10b are disposed so as to project from a first surface of a second divided plate member instead of from the mounting surface 4a.

The first positioning pin 10a is inserted through a first interfitting portion 25B that is constituted by the first interfitting aperture 18a and the fifth interfitting aperture 28a, and the second positioning pin 10b is inserted through a second interfitting portion 26B that is constituted by the second interfitting aperture 19a and the sixth interfitting aperture 29a.

A positioning mechanism 21D is constituted by the first positioning pin 10a, the second positioning pin 10b, the first interfitting portion 25B, and the second interfitting portion 26B. Here, internal shapes of the first interfitting portion 25B and the second interfitting portion 26B approximately match external shapes of the first positioning pin 10a and the second positioning pin 10b. Consequently, the positioning mechanism 21D positions the plate member 15A at a prescribed position on the mounting surface 4a and also restricts movement of the plate member 15A parallel to the mounting surface 4a by the fitting together of the first positioning pin 10a and the first interfitting portion 25B, and by the fitting together of the second positioning pin 10b and the second interfitting portion 26B.

A procedure for assembling the waveguide structure 1D includes stacking the first divided plate member 16a on the mounting surface 4a so as to align the first interfitting aperture 18a and the second interfitting aperture 19a with the fifth interfitting aperture 28a and the sixth interfitting aperture 29a, inserting the first positioning pin 10a and the second positioning pin 10b into the first interfitting portion 25B and the second interfitting portion 26B, then curving the first divided plate member 16a and the second divided plate member 22a parallel to the mounting surface 4a, and is completed by holding the first divided plate member 16a and the second divided plate member 22a using holders 11A.

According to the waveguide structure 1D of the third preferred variation, the construction that presses the plate member 15A onto the mounting surface 4a is similar to that of the waveguide structure 1A, and the first surface of the first divided plate member 16a is pressed onto the mounting surface 4a, and the first surface of the second divided plate member 22a is pressed onto the second surface of the first divided plate member 16a by a uniformly distributed load due to the reaction forces from the first divided plate member 16a and from the second divided plate member 22a.

Consequently, the waveguide structure 1D can be configured using metal without generating gaps that communicate between internal and external portions of the waveguide 7a.

The waveguide structure 1D also includes: a positioning mechanism 21D that has: a first positioning pin 10a and a second positioning pin 10b that are disposed so as to project from a rear surface of the second divided plate member 22a at a central portion in the curve direction so as to be separated in a sweep direction; and a first interfitting portion 25B and a second interfitting portion 26B that are formed on a base 2A and a first divided plate member 16a of a plate member 15A so as to have internal shapes that approximately match external shapes of the first positioning pin 10a and the second positioning pin 10b and together with which the first positioning pin 10a and the second positioning pin 10b are fitted.

Thus, the first divided plate member 16a and the second divided plate member 22a can be disposed accurately at a prescribed mounting position on the mounting surface 4a simply by stacking the first divided plate member 16a on the mounting surface 4a and inserting the first positioning pin 10a and the second positioning pin 10b of the second divided plate member 22a through the first interfitting portion 25B and the second interfitting portion 26B. Because movement of the first divided plate member 16a and the second divided plate member 22a other than in an axial direction of the first positioning pin 10a and the second positioning pin 10b is restricted when the first positioning pin 10a and the second positioning pin 10b have been inserted through the first interfitting portion 25B and the second interfitting portion 26B, the work of elastically deforming the first divided plate member 16a and the second divided plate member 22a over the mounting surface 4a is facilitated.

Consequently, according to the waveguide structure 1D, similar effects to those of the waveguide structure 1A can be achieved.

Moreover, in this third preferred variation, the first interfitting portion 25B and the second interfitting portion 26B are explained as being constituted by each of the interfitting apertures 18a, 19a, 23a, 24a, 28a, and 29a, but a first interfitting portion and a second interfitting portion may also be constituted by notches that are formed on the first divided plate member 16a and the base 2A so as to have internal shapes that conform to external shapes of the above positioning pins 10a and 10b with which they are fitted together, instead of each of the interfitting apertures 18a, 19a, 23a, 24a, 28a, and 29a.

The plate member 15A of the waveguide structure 1D is explained as being constituted by a two-layer divided plate member that is constituted by the first divided plate member 16a and the second divided plate member 22a. However, the plate member 15A may also be constituted by a divided plate member that has three or more layers by stacking additional divided plate members that are similar to the first divided plate member 16a between the second divided plate member 22a and the mounting surface 4a, etc., or the plate member 15A may be constituted by only the second divided plate member 22a.

Here, if the plate member 15A of the waveguide structure 1D is constituted only by the first divided plate member 16a, the divided plate member that fits together with the first positioning pin 10a and the second positioning pin 10b can be eliminated, and the first positioning pin 10a and the second positioning pin 10b that are disposed so as to protrude from the plate member 15A fit together directly with the fifth interfitting aperture 28a and the sixth interfitting aperture 29a that are formed on the main body portion 3A.

### Embodiment 2

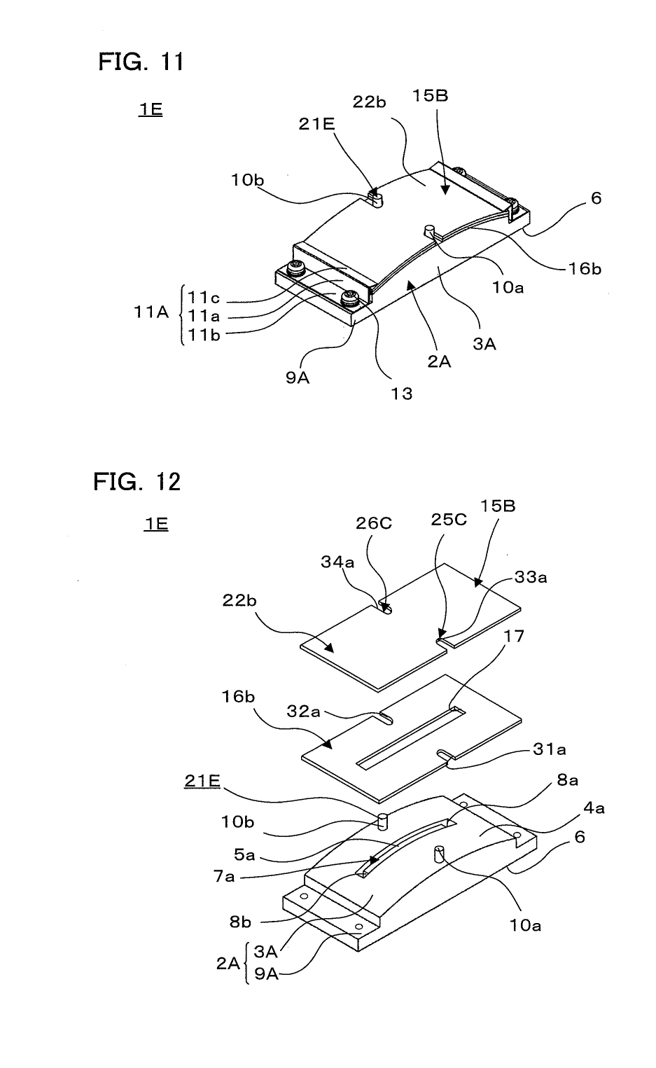

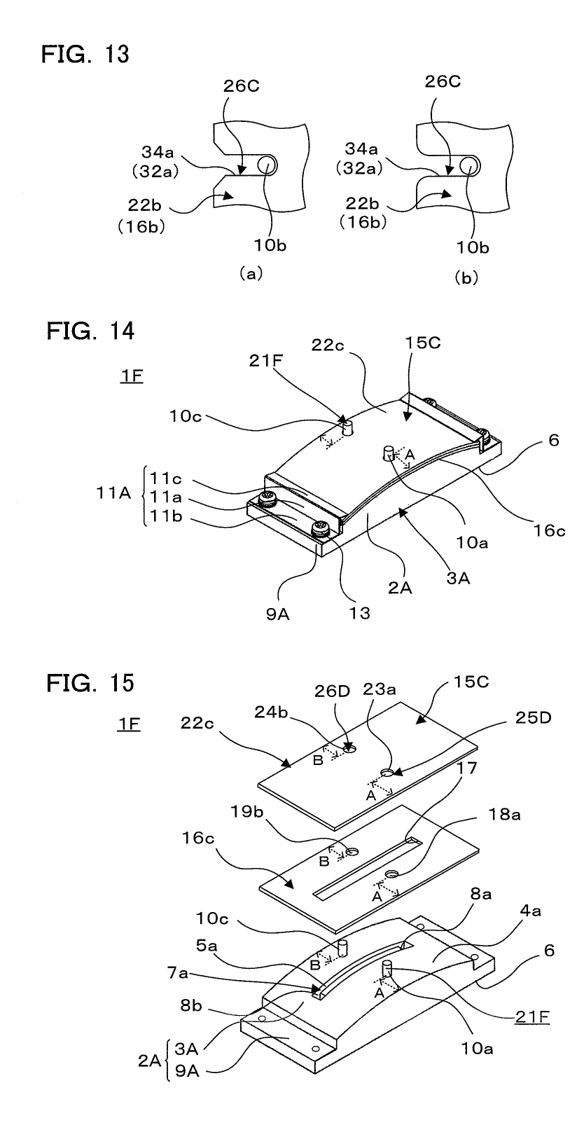

FIG. 11 is a perspective of a waveguide structure according to Embodiment 2 of the present invention, FIG. 12 is an exploded perspective of the waveguide structure according to Embodiment 2 of the present invention, and FIGS. 13A and 13B are partial front elevations of other variations of the waveguide structure according to Embodiment 2 of the present invention, FIGS. 13A and 13B showing preferred variations of the first plate member and the second plate member that have different notch shapes.

Moreover, in FIGS. 11 and 12, portions identical to or corresponding to those in Embodiment 1 above will be given identical numbering, and explanation thereof will be omitted.

In FIGS. 11 and 12, a waveguide structure 1E is configured in a similar manner to Embodiment 1 above except that a plate member 15B is used instead of the plate member 15A.

The plate member 15B includes: a first divided plate member 16b that is stacked on a mounting surface 4a; and a second divided plate member 22b that is stacked on the first divided plate member 16b. The first divided plate member 16b and the second divided plate member 22b are constituted by similar elastic metals.

The first divided plate member 16b is configured so as to have an approximately identical shape and similar size to those of the first divided plate member 16a. A first notch 31a and a second notch 32a that extend in a width direction of the first divided plate member 16b are formed so as to have a predetermined width and a predetermined depth on the first divided plate member 16b so as to have openings at intermediate portions in the longitudinal direction of two long sides thereof.

The second divided plate member 22b is configured so as to have an approximately identical shape and similar size to those of the second divided plate member 22a. A third notch 33a and a fourth notch 34a that extend in a width direction of the second divided plate member 22b are formed so as to have a predetermined width and a predetermined depth on the second divided plate member 22b so as to have openings at intermediate portions in the longitudinal direction of two long sides thereof.

Moreover, a width of the first through fourth notches 34a through 31a is slightly larger than a diameter of the first positioning pin 10a and the second positioning pin 10b. In other words, the width of the first through fourth notches 31a through 34a is formed so as to correspond to a length of the first positioning pin 10a and the second positioning pin 10b in the curve direction.

The first divided plate member 16b is stacked on the mounting surface 4a such that a first surface thereof faces the mounting surface 4a in a state in which the first positioning pin 10a and the second positioning pin 10b are inserted through the first notch 31a and the second notch 32a.

In addition, the second divided plate member 22b is stacked on the first divided plate member 16b such that a first surface thereof faces a second surface of the first divided plate member 16b in a state in which the first positioning pin 10a and the second positioning pin 10b are inserted through the third notch 33a and the fourth notch 34a.

Here, internal shapes of the first through fourth notches 34a through 31a conform to external shapes of the first positioning pin 10a and the second positioning pin 10b. In other words, depths of the first and third notches 31a and 33a and depths of the second and fourth notches 32a and 34a are set such that the first positioning pin 10a and the second positioning pin 10b face floor portions of the first through fourth notches 34a through 31a practically without leaving gaps.

The positioning mechanism 21E is constituted by the first positioning pin 10a, the second positioning pin 10b, a first interfitting portion 25C, which is constituted by the first notch 31a and the third notch 33a, and a second interfitting portion 26C, which is constituted by the second notch 32a and the fourth notch 34a.

Here, diameters of the first positioning pin 10a and the second positioning pin 10b are approximately equal to the widths of each of the notches 31a through 34a. Consequently, the positioning mechanism 21E positions the plate member 15B at a prescribed position on the mounting surface 4a and also restricts movement of the plate member 15B parallel to the mounting surface 4a by the fitting together of the first positioning pin 10a and the first interfitting portion 25C, and by the fitting together of the second positioning pin 10b and the second interfitting portion 26C.

The plate member 15B is held in a curved state so as to be placed in close contact with the mounting surface 4a by pressing forces from holders 11A.

Moreover, the plate member 15B being placed in close contact with the mounting surface 4a means that not only the first divided plate member 16b and the mounting surface 4a but also the first divided plate member 16b and the second divided plate member 22b are placed in close contact.

A procedure for assembling the waveguide structure 1E is similar to that of Embodiment 1 except that the first divided plate member 16b and the second divided plate member 22b are stacked onto the mounting surface 4a sequentially such that the first positioning pin 10a and the second positioning pin 10b are aligned with the first notch 31a and the third notch 33a and with the second notch 32a and the fourth notch 34a.

In a waveguide structure 1E that has been configured as described above, the construction that presses the plate member 15B onto the mounting surface 4a is similar to that of the waveguide structure 1A, and the first surface of the first divided plate member 16b is pressed onto the mounting surface 4a, and the first surface of the second divided plate member 22b is pressed onto the second surface of the first divided plate member 16b by a uniformly distributed load due to the reaction forces from the first divided plate member 16b and from the second divided plate member 22b.

Consequently, the waveguide structure 1E can be configured using metal without generating gaps that communicate between internal and external portions of the waveguide 7a.

The first divided plate member 16b and the second divided plate member 22b can be disposed accurately at a predetermined mounting position on the mounting surface 4a simply by inserting the first positioning pin 10a and the second positioning pin 10b through the first notch 31a and the second notch 32a, and through the third notch 33a and the fourth notch 34a, when stacking the first divided plate member 16b and the second divided plate member 22b on the mounting surface 4a. Movement of the first divided plate member 16b and the second divided plate member 22b is also restricted except in the axial direction of the first positioning pin 10a and the second positioning pin 10b.

Consequently, according to Embodiment 2, similar effects to those in Embodiment 1 above can be achieved.

Moreover, the widths of the above first through fourth notches 34a through 31a are explained as being slightly larger than lengths of the first positioning pin 10a and the second positioning pin 10b in the curve direction, but opening end corner portions of the second notch 32a and the fourth notch 34a may also be relieved by forming opening ends so as to have a tapered shape so as to become gradually wider toward the opening ends, or by machining the opening end corner portions so as to have a rounded shape, as shown in FIGS. 13A and 13B. Although not shown, opening ends of the first notch 31a and the third notch 33a may be also relieved in a similar manner.

By adopting a configuration of this kind, each of the notches 31a through 34a of the first divided plate member 16b and the second divided plate member 22b can be prevented from catching on members such as the first positioning pin 10a and the second positioning pin 10b, etc., as the first divided plate member 16b and the second divided plate member 22b are moved from predetermined places when performing an assembly operation for the waveguide structure 1E. In other words, large stresses can be prevented from acting on the first divided plate member 16b and the second divided plate member 22b that would plastically deform the first divided plate member 16b and the second divided plate member 22b.

Thus, because gaps are prevented from arising between internal and external portions the waveguides 7a due to a plastically deformed first divided plate member 16b or second divided plate member 22b being stacked on the mounting surface 4a, reliability of propagation of high frequency signals is further improved by using the waveguide structure 1E.

### Embodiment 3

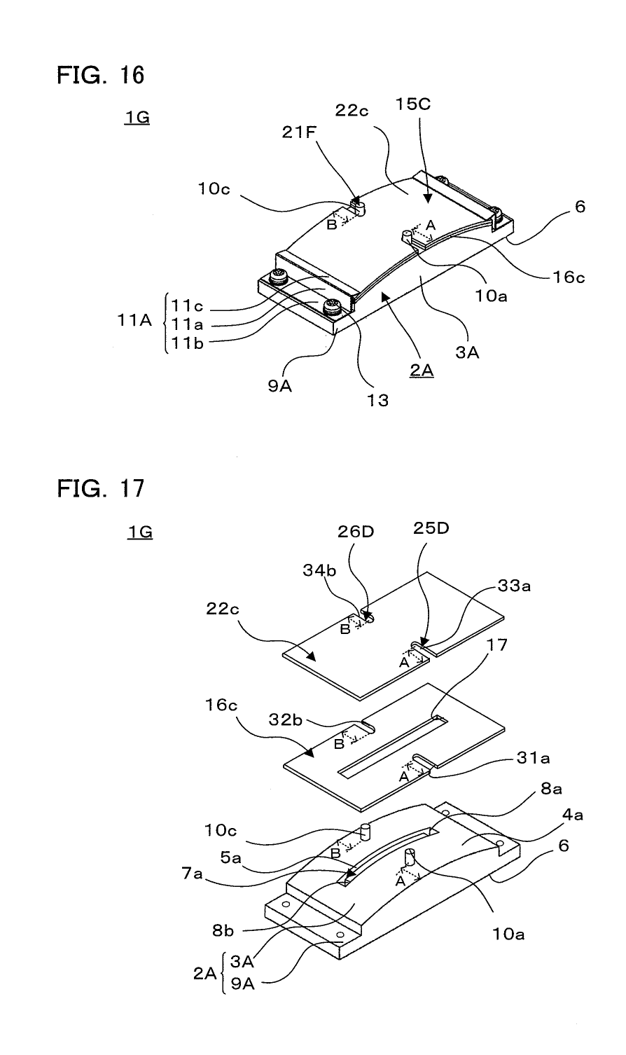

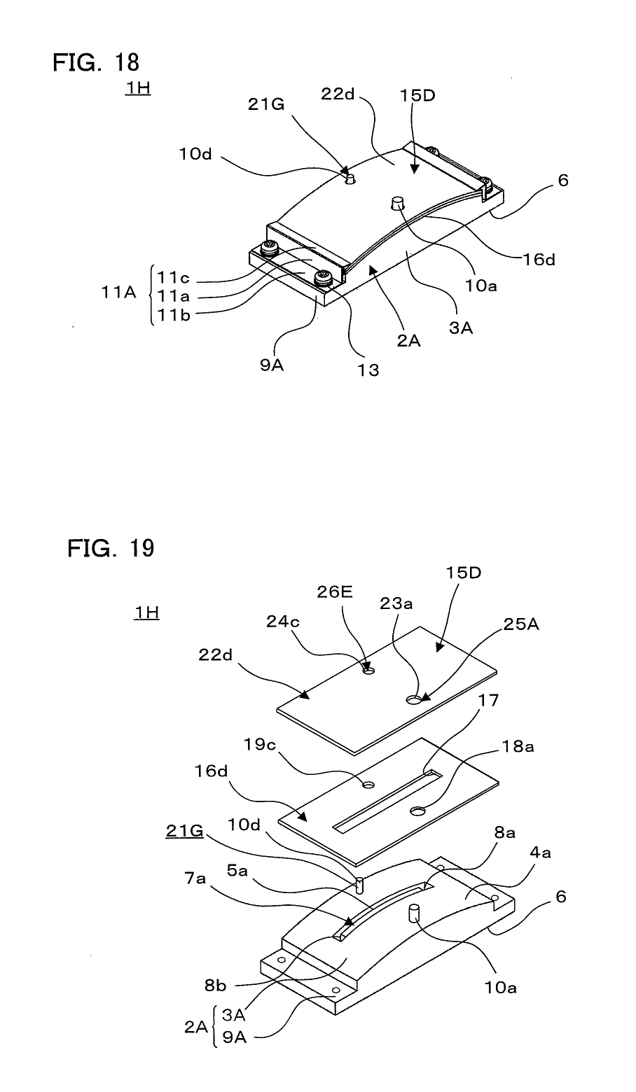

FIG. 14 is a perspective of a waveguide structure according to Embodiment 3 of the present invention, FIG. 15 is an exploded perspective of the waveguide structure according to Embodiment 3 of the present invention, FIG. 16 is a perspective of another variation of the waveguide structure according to Embodiment 3 of the present invention, and FIG. 17 is an exploded perspective of the other variation of the waveguide structure according to Embodiment 3 of the present invention.

Moreover, in FIGS. 14 through 17, portions identical to or corresponding to those in Embodiment 1 above will be given identical numbering, and explanation thereof will be omitted.

In FIGS. 14 and 15, a waveguide structure 1F is configured in a similar manner to Embodiment 1 above except that a second positioning pin 10c that functions as a positioning member is used instead of the second positioning pin 10b, and a plate member 15C is used instead of the plate member 15A.

The first positioning pin 10a is disposed so as to project from a portion of the mounting surface maximum projecting portion that is separated by a first distance A from a first edge portion in the sweep direction of the mounting surface 4a, as described above. The second positioning pin 10c is disposed so as to project from a portion of the mounting surface maximum projecting portion that is separated by a second distance B from a second edge portion in the sweep direction of the mounting surface 4a. In other words, the first positioning pin 10a and the second positioning pin 10c are disposed on opposite sides of center in the sweep direction so as to be asymmetrical relative to the center in the sweep direction.

The plate member 15C includes: a first divided plate member 16c that is stacked on a mounting surface 4a; and a second divided plate member 22c that is stacked on the first divided plate member 16c.

The first divided plate member 16c is configured in a similar manner to the first divided plate member 16a except that a second interfitting aperture 19b is formed instead of the second interfitting aperture 19a. Moreover, the second interfitting aperture 19b is formed on a portion of the first divided plate member 16c at a longitudinal center of the first divided plate member 16c, and separated by a second distance B from a second long side.

The second divided plate member 22c is configured in a similar manner to the second divided plate member 22a except that a fourth interfitting aperture 24b is formed instead of the fourth interfitting aperture 24a. Moreover, the fourth interfitting aperture 24b is formed on a portion of the second divided plate member 22c at a longitudinal center of the second divided plate member 22c, and separated by a second distance B from a second long side.

The first divided plate member 16c is stacked on the mounting surface 4a such that a first surface thereof faces the mounting surface 4a in a state in which the first positioning pin 10a and the second positioning pin 10c are inserted through the first interfitting aperture 18a and the second interfitting aperture 19b.

In addition, the second divided plate member 22c is stacked on the first divided plate member 16c such that a first surface thereof faces the first divided plate member 16c in a state in which the first positioning pin 10a and the second positioning pin 10c are inserted through the third interfitting aperture 23a and the fourth interfitting aperture 24b.

The positioning mechanism 21F is constituted by the first positioning pin 10a, the second positioning pin 10c, the first interfitting portion 25D, which is constituted by the first interfitting aperture 18a and the third interfitting aperture 23a, and the second interfitting portion 26D, which is constituted by the second interfitting aperture 19b and the fourth interfitting aperture 24b. Here, diameters of the first positioning pin 10a and the second positioning pin 10c are approximately equal to diameters of each of the interfitting apertures. Consequently, the positioning mechanism 21F positions the plate member 15C at a prescribed position on the mounting surface 4a and also restricts movement of the plate member 15C parallel to the mounting surface 4a by the fitting together of the first positioning pin 10a and the first interfitting portion 25D, and by the fitting together of the second positioning pin 10c and the second interfitting portion 26D.

The plate member 15C is held in a curved state so as to be placed in close contact with the mounting surface 4a by pressing forces from holders 11A.

A procedure for assembling the waveguide structure 1F is similar to that of Embodiment 1 except that the first divided plate member 16c and the second divided plate member 22c are stacked on the mounting surface 4a such that the first interfitting aperture 18a and the third interfitting aperture 23a are aligned with the first positioning pin 10a, and the second interfitting aperture 19b and the fourth interfitting aperture 24b are aligned with the second positioning pin 10c.

According to Embodiment 3, the first divided plate member 16c and the second divided plate member 22c can be disposed accurately at a prescribed position on the mounting surface 4a in a similar manner to Embodiment 1 simply by inserting the first positioning pin 10a and the second positioning pin 10c through the first interfitting aperture 18a and the second interfitting aperture 19b, and through the third interfitting aperture 23a and the fourth interfitting aperture 24b, when stacking the first divided plate member 16c and the second divided plate member 22c on the mounting surface 4a.

Moreover, the first positioning pin 10a and the second positioning pin 10c are disposed on opposite sides of center in the sweep direction so as to be asymmetrical relative to the center in the sweep direction.

Thus, when the first long sides and the second long sides of the first divided plate member 16c and the second divided plate member 22c are in positional relationships that are opposite to normal relative to the first and second long sides of the mounting surface 4a, the first positioning pin 10a and the second positioning pin 10c cannot be inserted through the first interfitting aperture 18a and the third interfitting aperture 23a, and through the second interfitting aperture 19b and the fourth interfitting aperture 24b.

In other words, the first divided plate member 16c and the second divided plate member 22c can be disposed on the mounting surface 4a only if the first divided plate member 16c and the second divided plate member 22c are aligned in a normal position relative to the mounting surface 4a, preventing workers from mounting the first divided plate member 16c and the second divided plate member 22c to the base 2A in an incorrect orientation.

Moreover, in the waveguide structure 1F according to Embodiment 3, the first interfitting portion 25D and the second interfitting portion 26D through which the first positioning pin 10a and the second positioning pin 10c are inserted are explained as being interfitting apertures that have an aperture shape that is circular. However, the first interfitting portion and the second interfitting portion are not limited to this shape, and as shown in FIG. 16 and FIG. 17, a waveguide structure 1G may also be configured such that a first notch 31a and a second notch 32b are formed on the first divided plate member 16c instead of the first interfitting aperture 18a and the second interfitting aperture 19b, and a third notch 33a and a fourth notch 34b are formed on the second divided plate member 22c instead of the third interfitting aperture 23a and the fourth interfitting aperture 24b. In that case, depth of the first notch 31a and the third notch 33a should be set so as to allow for the first distance A and a radius of the first positioning pin 10a, and depth of the second notch 32b and the fourth notch 34b should be set so as to allow for the second distance B and a radius of the second positioning pin 10c. Similar effects to those of the waveguide structure IF can be also achieved by a waveguide structure 1G that is configured in this manner.

### Embodiment 4

FIG. 18 is a perspective of a waveguide structure according to Embodiment 4 of the present invention, and FIG. 19 is an exploded perspective of the waveguide structure according to Embodiment 4 of the present invention.

Moreover, in FIGS. 18 and 19, portions identical to or corresponding to those in Embodiment 1 above will be given identical numbering, and explanation thereof will be omitted.

In FIGS. 18 and 19, a waveguide structure 1H is configured in a similar manner to Embodiment 1 above except that a second positioning pin 10d is disposed so as to project from the mounting surface 4a instead of the second positioning pin 10b, and a plate member 15D is used instead of the plate member 15A.

The second positioning pin 10d has a circular external shape, and has a smaller diameter than that of the second positioning pin 10b, and the diameters of the second positioning pin 10d and the first positioning pin 10a are different from each other.

The plate member 15D includes: a first divided plate member 16d that is stacked on a mounting surface 4a; and a second divided plate member 22d that is stacked on the first divided plate member 16d.

The first divided plate member 16d is configured in a similar manner to the first divided plate member 16a of the waveguide structure 1A except that a second interfitting aperture 19c that has an internal shape that approximately matches an external shape of the second positioning pin 10d is formed instead of the second interfitting aperture 19a.

The second divided plate member 22d is configured in a similar manner to the second divided plate member 22a of the waveguide structure 1A except that a fourth interfitting aperture 24b that has an internal shape that approximately matches the external shape of the second positioning pin 10d is formed instead of the fourth interfitting aperture 24a.

The first divided plate member 16d is stacked on the mounting surface 4a such that a first surface thereof faces the mounting surface 4a in a state in which the first positioning pin 10a and the second positioning pin 10d are inserted through the first interfitting aperture 18a and the second interfitting aperture 19c. In addition, the second divided plate member 22d is stacked on the first divided plate member 16d such that a first surface thereof faces the first divided plate member 16d in a state in which the first positioning pin 10a and the second positioning pin 10d are inserted through the third interfitting aperture 23a and the fourth interfitting aperture 24c.

The positioning mechanism 21G is constituted by the first positioning pin 10a, the second positioning pin 10d, the first interfitting portion 25A, and the second interfitting portion 26E, which is constituted by the second interfitting aperture 19c and the fourth interfitting aperture 24c. Here, a diameter of the first positioning pin 10a approximately matches diameters of the first interfitting aperture 18a and the third interfitting aperture 23a, and a diameter of the second positioning pin 10d approximately matches diameters of the second interfitting aperture 19c and the fourth interfitting aperture 24c. Consequently, the positioning mechanism 21G positions the plate member 15D at a prescribed position on the mounting surface 4a and also restricts movement parallel to the mounting surface 4a by the fitting together of the first positioning pin 10a and the first interfitting portion 25A and the second positioning pin 10d and the second interfitting portion 26E.

The plate member 15D is held in a curved state so as to be placed in close contact with the mounting surface 4a by pressing forces from holders 11A.

A procedure for assembling the waveguide structure 1H is similar to that of Embodiment 1 except that the second interfitting aperture 19c and the fourth interfitting aperture 24c are aligned with the second positioning pin 10d.

According to Embodiment 4, the first divided plate member 16d and the second divided plate member 22d can be disposed accurately at a prescribed position on the mounting surface 4a in a similar manner to Embodiment 1 simply by inserting the first positioning pin 10a and the second positioning pin 10d through the first interfitting aperture 18a and the second interfitting aperture 19c, and through the third interfitting aperture 23a and the fourth interfitting aperture 24c, when stacking the first divided plate member 16d and the second divided plate member 22d on the mounting surface 4a.

Moreover, the first positioning pin 10a and the second positioning pin 10d are configured so as to have different diameters (shapes). In addition, the internal shape of the first interfitting portion 25A corresponds to the external shape of the first positioning pin 10a, and the internal shape of the second interfitting portion 26E corresponds to the external shape of the second positioning pin 10d.

Thus, when the first and second long sides of the first divided plate member 16d and the second divided plate member 22d are in positional relationships that are opposite to normal relative to the first and second edge portions of the mounting surface 4a in the sweep direction, the first positioning pin 10a and the second positioning pin 10d cannot be inserted through the first divided plate member 16d and the second divided plate member 22d. In other words, the first positioning pin 10a can be inserted through the first interfitting aperture 18a and the third interfitting aperture 23a, the second positioning pin 10d can be inserted through the second interfitting aperture 19c and the fourth interfitting aperture 24c, and the first divided plate member 16d and the second divided plate member 22d can be disposed on the mounting surface 4a only if the first divided plate member 16d and the second divided plate member 22d are aligned correctly relative to the mounting surface 4a. Consequently, the first divided plate member 16d and the second divided plate member 22d can be prevented in advance from being mounted to the base 2A in an incorrect orientation.

Now, even in a positioning mechanism that is configured using positioning pins that have identical diameters that are disposed so as to protrude from the mounting surface 4a so as to be offset in position in the curve direction of the mounting surface 4a, and interfitting apertures that are formed on portions of the first divided plate member and the second divided plate member that correspond to each of the positioning pins, the first divided plate member and the second divided plate member can be stacked on the mounting surface 4a without making a mistake in the orientations of the first divided plate member and the second divided plate member. If the position of the pair of positioning pins is offset in the curve direction, it is necessary for diameters of the interfitting apertures of the first divided plate member and the second divided plate member to have a larger clearance relative to diameters of the positioning pins that fit together with them.

The waveguide structure 1H according to Embodiment 4 is effective when the first positioning pin 10a and the second positioning pin 10d are disposed so as to protrude from a predetermined position in the curve direction of the mounting surface 4a, and neither of the positioning pins can be disposed so as to protrude from a position that is offset in the curve direction. Clearance between the first interfitting portion 25A and the first positioning pin 10a, and clearance between the second interfitting portion 26E and the second positioning pin 10d can be set to a required minimum. In other words, in the waveguide structure 1H, the first divided plate member 16d and the second divided plate member 22d can be prevented from being stacked on the mounting surface 4a in an incorrect orientation while ensuring positioning precision of the first divided plate member 16d and the second divided plate member 22d at the prescribed position on the mounting surface 4a.

### Embodiment 5

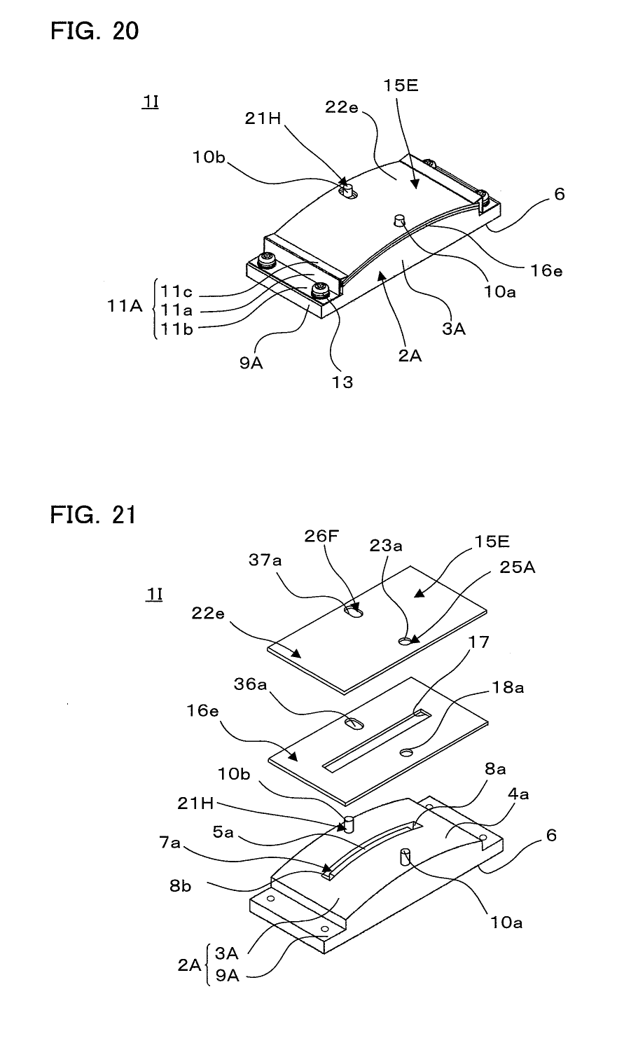

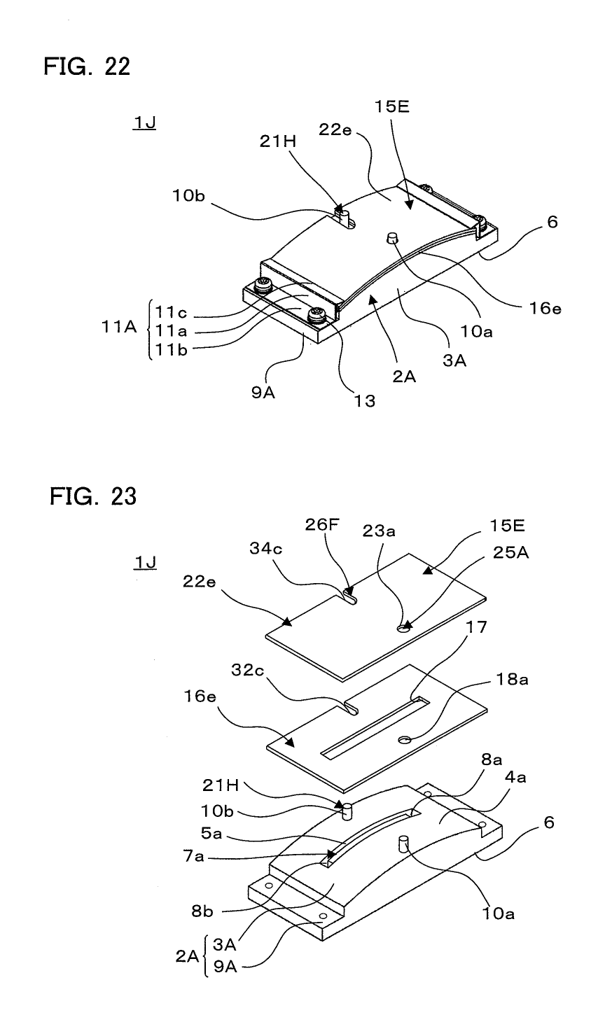

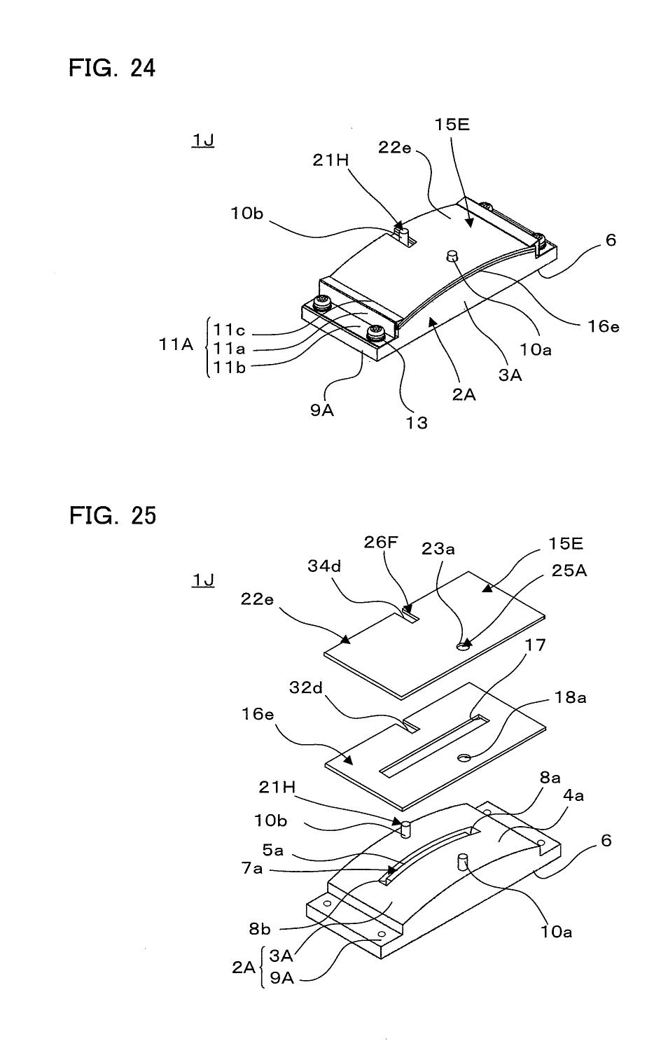

FIG. 20 is a perspective of a waveguide structure according to Embodiment 5 of the present invention, and FIG. 21 is an exploded perspective of the waveguide structure according to Embodiment 5 of the present invention. FIG. 22 is a perspective of another variation of the waveguide structure according to Embodiment 5 of the present invention, and FIG. 23 is an exploded perspective of the other variation of the waveguide structure according to Embodiment 5 of the present invention. FIG. 24 is a perspective of yet another variation of the waveguide structure according to Embodiment 5 of the present invention, and FIG. 25 is an exploded perspective of that other variation of the waveguide structure according to Embodiment 5 of the present invention.

Moreover, in FIGS. 20 through 25, portions identical to or corresponding to those in Embodiment 1 above will be given identical numbering, and explanation thereof will be omitted.

In FIGS. 20 and 21, a waveguide structure 1I is configured in a similar manner to Embodiment 1 above except that a plate member 15E is used instead of the plate member 15A.

The plate member 15E includes: a first divided plate member 16e that is stacked on a mounting surface 4a; and a second divided plate member 22e that is stacked on the first divided plate member 16e.

The first divided plate member 16e is similar in configuration to the first divided plate member 16a of the waveguide structure 1A except that a slot-shaped second interfitting aperture 36a is formed instead of the second interfitting aperture 19a.

The second divided plate member 22e is similar in configuration to the second divided plate member 22a of the waveguide structure 1A except that a slot-shaped fourth interfitting aperture 24b is formed instead of the fourth interfitting aperture 24a.

The second interfitting aperture 36a and the fourth interfitting aperture 37a are formed such that major axes are oriented in a width direction of the first divided plate member 16e and the second divided plate member 22e.

Minor axial lengths of the second interfitting aperture 36a and the fourth interfitting aperture 37a are slightly longer than a diameter of the second positioning pin 10b when the curved first divided plate member 16e and second divided plate member 22e are viewed from a direction that faces their respective major surfaces. In other words, the minor axial lengths of the second interfitting aperture 36a and the fourth interfitting aperture 37a are set so as to correspond to a length of the second positioning pin 10b in the curve direction.

Major axial lengths of the second interfitting aperture 36a and the fourth interfitting aperture 37a are determined with consideration for an amount of permissible drift in the distance between the first interfitting aperture 18a and the second interfitting aperture 36a from a design perspective, an amount of permissible drift in the distance between the third interfitting aperture 23a and the fourth interfitting aperture 37a from a design perspective, an amount of relative drift in the first divided plate member 16e and the second divided plate member 22e relative to each of the positioning pins 10a and 10b allowing for age-related changes, and an amount of relative drift in the first divided plate member 16e and the second divided plate member 22e relative to each of the positioning pins 10a and 10b allowing for differences in coefficient of linear expansion if the first divided plate member 16e and the second divided plate member 22e are constituted by different metals.

The first divided plate member 16e is stacked on the mounting surface 4a such that a first surface thereof faces the mounting surface 4a in a state in which the first positioning pin 10a and the second positioning pin 10b are inserted through the first interfitting aperture 18a and the second interfitting aperture 36a.

In addition, the second divided plate member 22e is stacked on the first divided plate member 16e such that a first surface thereof faces the first divided plate member 16e in a state in which the first positioning pin 10a and the second positioning pin 10b are inserted through the third interfitting aperture 23a and the fourth interfitting aperture 37a.

The positioning mechanism 21H is constituted by the first positioning pin 10a, the second positioning pin 10b, the first interfitting portion 25A, and the second interfitting portion 26F, which is constituted by the second interfitting aperture 36a and the fourth interfitting aperture 37a.

Here, because the diameters of the first interfitting aperture 18a and the third interfitting aperture 23a are approximately equal to the diameter of the first positioning pin 10a, movement of the first divided plate member 16e and the second divided plate member 22e is restricted other than in the circumferential direction and the axial direction of the first positioning pin 10a. In addition, the minor axial lengths of the second interfitting aperture 36a and the fourth interfitting aperture 37a are approximately equal to the diameter of the second positioning pin 10b. Thus, the positioning mechanism 21H positions the plate member 15E at a prescribed position on the mounting surface 4a and also restricts movement of the plate member 15E parallel to the mounting surface 4a by the fitting together of the first positioning pin 10a and the first interfitting portion 25A, and by the fitting together of the second positioning pin 10b and the second interfitting portion 26F.

Moreover, the second interfitting aperture 36a and the fourth interfitting aperture 37a are for the purpose of restricting rotation of the first divided plate member 16e and the second divided plate member 22e around an axis of the first positioning pin 10a, and do not particularly require major axial length precision provided that management of minor axial length precision is performed.

The plate member 15E is held in a curved state so as to be placed in close contact with the mounting surface 4a by pressing forces from holders 11A.

In an initial state of the waveguide structure 1I, predetermined gaps or greater are formed between the second interfitting aperture 36a and the second positioning pin 10b and between the fourth interfitting aperture 37a and the second positioning pin 10b on the major axis of the second interfitting aperture 36a and the fourth interfitting aperture 37a. The second positioning pin 10b can thereby be prevented from colliding with the first divided plate member 16e and the second divided plate member 22e even if relative drift arises between the second positioning pin 10b and the first divided plate member 16e and between the second positioning pin 10b and the second divided plate member 22e as a result of differences in coefficient of linear expansion between the members and age-related changes.

A procedure for assembling the waveguide structure 1I is similar to that of Embodiment 1 except that the first divided plate member 16e and the second divided plate member 22e are stacked onto the mounting surface 4a sequentially such that the second positioning pin 10b is aligned with the second interfitting aperture 36a and the fourth interfitting aperture 37a.

According to Embodiment 5, the first divided plate member 16e and the second divided plate member 22e can be disposed accurately at a prescribed mounting position on the mounting surface 4a by disposing the first divided plate member 16e and the second divided plate member 22e so as to insert the first positioning pin 10a through the first interfitting aperture 18a and the third interfitting aperture 23a and insert the second positioning pin 10b through the second interfitting aperture 36a and the fourth interfitting aperture 24b, when stacking the first divided plate member 16e and the second divided plate member 22e on the mounting surface 4a.

Moreover, by using a configuration in which the second positioning pin 10b is inserted through the second interfitting aperture 36a and the fourth interfitting aperture 37a, it is possible to insert the first positioning pin 10a and the second positioning pin 10b through the first interfitting aperture 18a and the third interfitting aperture 23a and the second interfitting aperture 36a and the fourth interfitting aperture 37a without any problem even if processing deviations arise relative to the major axis of the second interfitting aperture 36a, for example, in the distances between the first positioning pin 10a and the second positioning pin 10b, between the first interfitting aperture 18a and the second interfitting aperture 36a, and between the third interfitting aperture 23a and the fourth interfitting aperture 37a. In other words, it becomes possible to support the first divided plate member 16e and the second divided plate member 22e on the base 2A such that neither the first positioning pin 10a and the first interfitting aperture 18a or the third interfitting aperture 23a nor the second positioning pin 10b and the second interfitting aperture 36a or the fourth interfitting aperture 37a will press on each other.

If, due to differences in coefficient of linear expansion of the base 2A, the first divided plate member 16e, and the second divided plate member 22e, or age-related changes, etc., each of the members expands or contracts, the first divided plate member 16e and the second divided plate member 22e will expand and contract relative to the interfitting portion of the first positioning pin 10a. Here, if the first positioning pin 10a and the first interfitting aperture 18a drift from each other by a distance D along the minor axis of the second interfitting aperture 36a, for example, minor axial drift between the second positioning pin 10b and the second interfitting aperture 36a will also be the distance D. However, if the first positioning pin 10a and the first interfitting aperture 18a drift along the major axis of the second interfitting aperture 36a by a distance D, the amount of relative drift on the major axis between the second positioning pin 10b and the second interfitting aperture 36a will be greater than the distance D in proportion to the distance between the first interfitting aperture 18a and the second interfitting aperture 36a. Moreover, relative drift along the major axis between the second positioning pin 10b and the fourth interfitting aperture 37a is also similar.

In the waveguide structure 1I, large gaps are formed in advance on first and second major axial sides of the second positioning pin 10b. Consequently, even if the relative positional relationship in the major axis between the second positioning pin 10b and the second interfitting aperture 36a or the fourth interfitting aperture 37a drifts significantly as a result of differences in coefficient of linear expansion of the base 2A, the first divided plate member 16e, and the second divided plate member 22e, or age-related changes, etc., the second positioning pin 10b will not collide into the walls at the first and second major axial ends of the second interfitting aperture 36a or the fourth interfitting aperture 37a due to that drift. Large pressing forces can thereby be prevented from arising between the second positioning pin 10b and the second interfitting aperture 36a or between the second positioning pin 10b and the fourth interfitting aperture 37a, preventing the first divided plate member 16e and the second divided plate member 22e from deforming plastically and warping, etc.

By reducing clearance between the first positioning pin 10a and the first interfitting aperture 18a and between the first positioning pin 10a and the third interfitting aperture 23a, and clearance between the second positioning pin 10b and the second interfitting aperture 36a and between the second positioning pin 10b and the fourth interfitting aperture 37a in the width direction of the second positioning pin 10b to a limit in a range that is permitted by cost without irregularities, positioning precision of the first divided plate member 16e and the second divided plate member 22e on the mounting surface 4a can be improved further.

Moreover, in Embodiment 5, restriction of rotation of the first divided plate member 16e and the second divided plate member 22e in a circumferential direction of the first positioning pin 10a is explained as being performed by the second interfitting aperture 36a and the fourth interfitting aperture 37a and by the second positioning pin 10b that has been inserted into the second interfitting aperture 36a and the fourth interfitting aperture 37a.

However, restriction of rotation of the first divided plate member 16e and the second divided plate member 22e in the circumferential direction of the first positioning pin 10a is not limited to this. As shown in FIGS. 22 and 23, a waveguide structure 1J may also be configured by forming a second notch 32c and a fourth notch 34c on the first divided plate member 16e and the second divided plate member 22e instead of the second interfitting aperture 36a and the fourth interfitting aperture 37a of the waveguide structure 1I, and inserting the second positioning pin 10b through the second notch 32c and the fourth notch 34c. In that case, the second notch 32c and the fourth notch 34c may be configured so as to extend in the sweep direction so as to have a width that is slightly larger than the diameter of the first positioning pin 10a and so as to have a floor portion that is configured so as to have a semicircular shape, for example. As shown in FIGS. 24 and 25, a waveguide structure 1J may also be configured by forming a second notch 32d and a fourth notch 34d that have a rectangular shape instead of the second interfitting aperture 36a and the fourth interfitting aperture 37a of the waveguide structure 1I, and inserting the second positioning pin 10b through the second notch 32d and the fourth notch 34d.

Using a waveguide structure 1J that is configured in this manner, rotation of the first divided plate member 16e and the second divided plate member 22e in the circumferential direction of the first positioning pin 10a can also be restricted and the first divided plate member 16a and the second divided plate member 22a can be disposed accurately at the prescribed position on the mounting surface 4a, and drift, etc., of the mounting surface 4a, the first divided plate member 16e, and the second divided plate member 22e that results from differences in coefficient of linear expansion between the members, age-related changes, etc., can also be accounted for. Consequently, similar effects to those of the waveguide structure 1I can also be achieved by the waveguide structure 1J.

### Embodiment 6

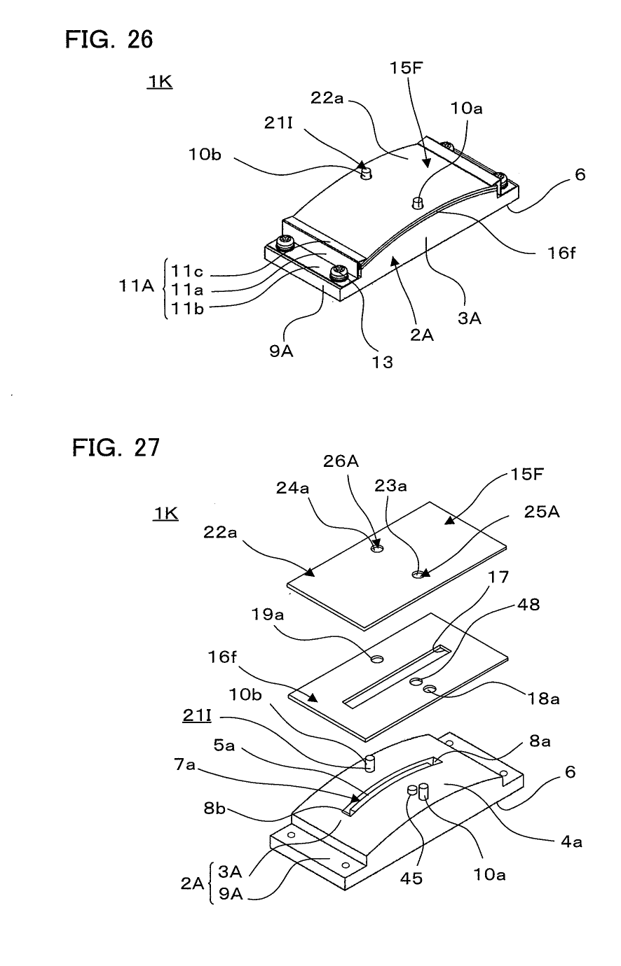

FIG. 26 is a perspective of a waveguide structure according to Embodiment 6 of the present invention, and FIG. 27 is an exploded perspective of the waveguide structure according to Embodiment 6 of the present invention.

Moreover, in FIGS. 26 and 27, portions identical to or corresponding to those in Embodiment 1 above will be given identical numbering, and explanation thereof will be omitted.

In FIGS. 26 and 27, a waveguide structure 1K is configured in a similar manner to Embodiment 1 above except that a stacking number corresponding interfitting pin 45 that functions as a stacking sequence regulating pin is disposed so as to project from a mounting surface maximum projecting portion between a waveguide groove 5a and a first positioning pin 10a at a third distance position from a first edge portions in the sweep direction, and a plate member 15F is used instead of the plate member 15A.

The plate member 15F includes: a first divided plate member 16f that is stacked on a mounting surface 4a; and a second divided plate member 22a that is stacked on the first divided plate member 16f.

A sequence regulating interfitting aperture 48 that functions as a stacking sequence regulating interfitting portion that has an aperture shape that is circular is formed on a portion of the first divided plate member 16f that is central in the longitudinal direction of the first divided plate member 16f, and that is separated by the third distance from a first long side. Moreover, the rest of the configuration of the first divided plate member 16f is similar to that of the first divided plate member 16a of the waveguide structure 1A.

An amount of protrusion of the stacking number corresponding interfitting pin 45 from the mounting surface 4a is set so as to be less than a thickness of the first divided plate member 16f.

Moreover, permissible errors in position on the mounting surface 4a and in diameter are set so as to be somewhat larger than the stacking number corresponding interfitting pin 45. The sequence regulating interfitting aperture 48 is formed with a rough milling precision so as to have a large diameter that allows a margin around the diameter of the stacking number corresponding interfitting pin 45 so as to enable fitting together with the stacking number corresponding interfitting pin 45 giving consideration to the permissible error in position on the mounting surface 4a and in diameter of the stacking number corresponding interfitting pin 45.

The first divided plate member 16f is stacked on the mounting surface 4a such that the first positioning pin 10a is inserted through a first interfitting aperture 18a, the stacking number corresponding interfitting pin 45 is inserted into the sequence regulating interfitting aperture 48, and the second positioning pin 10b is inserted through the second interfitting aperture 19a. The second divided plate member 22a is stacked on the first divided plate member 16f such that the first positioning pin 10a is inserted into the second interfitting aperture 23a, and the second positioning pin 10b is inserted through the fourth interfitting aperture 24a.

Here, a positioning mechanism 21I is constituted by the first positioning pin 10a, the second positioning pin 10b, the first interfitting portion 25A, and the second interfitting portion 26A. The positioning mechanism 21I positions the plate member 15F at a prescribed position on the mounting surface 4a and also restricts movement parallel to the mounting surface 4a by the fitting together of the first positioning pin 10a and the first interfitting portion 25A and the second positioning pin 10b and the second interfitting portion 26A.

The first positioning pin 10a and the second positioning pin 10b, and the stacking number corresponding interfitting pin 45 have respective heights that correspond to two plates and one plate, which is the respective number of stacked plates in the two-plate divided plate member that is constituted by the first divided plate member 16f and the second divided plate member 22a, and are each disposed so as to project from the mounting surface 4a so as to line up in the sweep direction. The sequence regulating interfitting aperture 48, a first interfitting aperture 18a, and a second interfitting aperture 19a that fit together with the stacking number corresponding interfitting pin 45, the first positioning pin 10a, and the second positioning pin 10b are formed on the first divided plate member 16f that is positioned in a first layer on the mounting surface 4a. A first interfitting aperture 18a and a second interfitting aperture 19a that fit together with the first positioning pin 10a, and the second positioning pin 10b are formed on the second divided plate member 22a that is positioned in a second layer on the mounting surface 4a.

The plate member 15F is held in a curved state so as to be placed in close contact with the mounting surface 4a by pressing forces from holders 11A.

A procedure for assembling the waveguide structure 1K is similar to that of Embodiment 1 except that when the first divided plate member 16f is stacked on the mounting surface 4a, the first interfitting aperture 18a is aligned with the first positioning pin 10a, the second interfitting aperture 19a is aligned with the second positioning pin 10c, the sequence regulating interfitting aperture 48 is also aligned with the stacking number corresponding interfitting pin 45, and the first divided plate member 16f is stacked on the mounting surface 4a.

According to the waveguide structure 1K according to Embodiment 6, the plate member 15F is constituted by a two-plate divided plate member 16f and 22a that is stacked on the mounting surface 4a of the base 2A. The stacking number corresponding interfitting pin 45 and the first positioning pin 10a (or the second positioning pin 10b) are disposed so as to project from the mounting surface 4a so as to line up in a sweep direction. The stacking number corresponding interfitting pin 45 and the first positioning pin 10a have respective heights that correspond to one plate and two plates, which is the respective number of stacked plates in the two-plate divided plate member that is constituted by the first divided plate member 16f and the second divided plate member 22a.

In the two-plate divided plate member 16f and 22a, the sequence regulating interfitting aperture 48 and the first interfitting aperture 18a that fit together with the stacking number corresponding interfitting pin 45 and the positioning pin 10a that have heights that correspond to the respective number of stacked plates, which are the first plate and the second plate divided plate member 16f and 22a, are formed on portions of the divided plate members 16f and 22a.

Thus, even if an attempt is made to stack the first divided plate member 16f and the second divided plate member 22a onto the mounting surface 4a in an incorrect stacking sequence, the second divided plate member 22a cannot be disposed directly on the mounting surface 4a because an interfitting aperture that corresponds to the stack number corresponding interfitting pin 45 has not been formed on the second divided plate member 22a.

In other words, the first positioning pin 10a and the second positioning pin 10b function as the only stacking sequence regulating pins that fit together with the second divided plate member 22a in the uppermost layer (in this case, the second layer), and the first interfitting portion 25A and the second interfitting portion 26A also function as stacking sequence regulating interfitting portions that correspond to the first positioning pin 10a and the second positioning pin 10b that only fit together with the second divided plate member 22a of the uppermost layer.

Consequently, according to the waveguide structure 1K, effects can be achieved such as preventing the first divided plate member 16f and the second divided plate member 22a from being stacked on the mounting surface 4a in an incorrect stacking sequence in addition to the effects of Embodiment 1.

Positioning accuracy between the stack number corresponding interfitting pin 45 and the sequence regulating interfitting aperture 48 may be rougher than positioning accuracy between the first positioning pin 10a and the first interfitting aperture 18a and between the first positioning pin 10a and the third interfitting aperture 23a, or positioning accuracy between the second positioning pin 10b and the second interfitting aperture 19a and between the second positioning pin 10b and the fourth interfitting aperture 24a. Consequently, the waveguide structure 1K makes it possible to include a function that prevents errors in the stacking sequence of the first divided plate member 16a and the second divided plate member 22a while suppressing machining costs.

Moreover, in Embodiment 6, the first positioning pin 10a and the second positioning pin 10b are explained as also functioning as a stack number corresponding interfitting pin 45 that has a height that corresponds to the number of stacked plates, i.e., the two plates in the divided plate member 16f and 22a, but a stacking sequence regulating pin that has a height that corresponds to the number of stacked plates (the two plates of the divided plate member 16f and 22a) may also be disposed separately from the first positioning pin 10a and the second positioning pin 10b.

However, by making the first positioning pin 10a and the second positioning pin 10b also function as a stacking sequence regulating pin that has a height that corresponds to the number of stacked plates (the two plates of the divided plate member 16f and 22a), reductions in the cost of the waveguide structure 1K, and additional reductions in the size of the waveguide structure 1K can be achieved from the viewpoint of reduction in the number of parts.

The plate member 15F is explained as being constituted by two plates that are constituted by the first divided plate member 16f and the second divided plate member 22a, but the plate member is not limited to being constituted by two divided plate members, and may also be constituted by n divided plate members (where n is an integer that is greater than or equal to 2). In that case, n stacking number corresponding intermitting pins 45 that function as stacking sequence regulating pins that respectively have a height that corresponds to each of the number of stacked plates in the divided plate members from one plate to n plates may be disposed so as to protrude from the mounting surface 4a of the base 2A in a single row in the sweep direction with the first positioning pin 10a and the second positioning pin 10b. Here, positioning pins 10a and 10b may also serve as stacking number corresponding interfitting pins that function as stacking sequence regulating pins that have a height that corresponds to n plates in the number of plates stacked in the divided plate member. Interfitting apertures that function as stacking sequence regulating interfitting portions that fit together with the stacking number corresponding interfitting pins 45 that have heights that correspond to the respective number of plates stacked in n divided plate members from one plate to m plates (where m is an integer that is greater than or equal to 1 and less than or equal to n) should respectively be formed on the divided plate members that are stacked on the mounting surface 4a up to an m-th layer.

### Embodiment 7

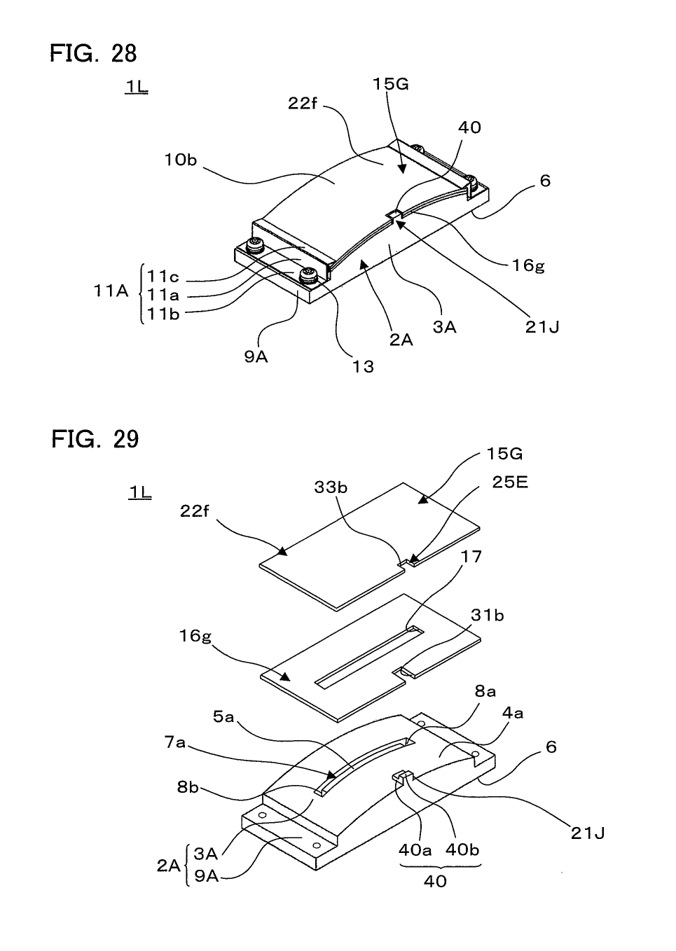

FIG. 28 is a perspective of a waveguide structure according to Embodiment 7 of the present invention, and FIG. 29 is an exploded perspective of the waveguide structure according to Embodiment 7 of the present invention.

Moreover, in FIGS. 28 and 29, portions identical to or corresponding to those in Embodiment 1 above will be given identical numbering, and explanation thereof will be omitted.

In FIGS. 28 and 29, a waveguide structure 1L is configured in a similar manner to Embodiment 1 above except that a stepped protruding portion 40 that functions as a positioning member and a stacking sequence regulating member is disposed so as to project from the mounting surface 4a, a plate member 15G is used instead of the plate member 15A, and the first positioning pin 10a and the second positioning pin 10b are omitted.

The stepped protruding portion 40 is disposed so as to project from a mounting surface maximum projecting portion of the mounting surface 4a near a first edge portion in the sweep direction. Here, an external shape of a cross section that is perpendicular to the direction of projection of the stepped protruding portion 40 is quadrilateral. The stepped protruding portion 40 is formed so as to have a stepped shape in which a height from the mounting surface 4a becomes lower at predetermined positions from a first end toward a second end in the sweep direction. Here, a surface of a first step that is parallel to the mounting surface 4a will be called “a first step surface”, and a surface of a second step that is parallel to the mounting surface 4a will be called “a second step surface”.

A portion of the stepped protruding portion 40 that is constituted from the mounting surface 4a to the first step surface in the direction of protrusion of the stepped protruding portion 40 from the mounting surface 4a will be designated “a first step portion 40a”, and a portion of the stepped protruding portion 40 that is constituted from the first step surface to the second step surface will be designated “a second step portion 40b”.

Moreover, a thickness direction of the first step portion 40a and the second step portion 40b is the direction of projection of the stepped protruding portion 40. Length of the stepped protruding portion 40 in the curve direction is constant irrespective of position in the sweep direction.

The plate member 15G is constituted by: a first divided plate member 16g that is stacked on a mounting surface 4a; and a second divided plate member 22f that is stacked on the first divided plate member 16g.

The first divided plate member 16g is configured in a similar manner to the first divided plate member 16a of the waveguide structure 1A except that a first notch 31b is formed instead of the first interfitting aperture 18a, and formation of the second interfitting aperture 19a is omitted.

Here, a shape of the first notch 31b corresponds to an external shape of the first step portion 40a when viewed from the direction of projection of the stepped protruding portion 40.

The second divided plate member 22f is configured in a similar manner to the second divided plate member 22a of the waveguide structure 1A except that a third notch 33b is formed instead of the third interfitting aperture 23a, and formation of the fourth interfitting aperture 24a is omitted. Here, a shape of the third notch 33b corresponds to an external shape of the second step portion 40b when viewed from the direction of projection of the stepped protruding portion 40 from the mounting surface 4a.

The first divided plate member 16g is stacked on the mounting surface 4a such that the first step portion 40a of the stepped protruding portion 40 is fitted together with the first notch 31b practically without leaving gaps. Here, a thickness of the first divided plate member 16g matches a thickness of the first step portion 40a. In addition, the second divided plate member 22f is stacked on the first divided plate member 16g such that the second step portion 40b of the stepped protruding portion 40 is fitted together with the third notch 33b practically without leaving gaps.

The positioning mechanism 21J is constituted by the stepped protruding portion 40 and a first interfitting portion 25E that is constituted by the first notch 31b and the third notch 33b. Because the first notch 31b and the third notch 33b have internal shapes that match the external shape of the stepped protruding portion 40, the positioning mechanism 21J positions the plate member 15G at a prescribed position on the mounting surface 4a and also restricts rotational movement of the plate member 15G around the stepped protruding portion 40 parallel to the mounting surface 4a by the fitting together of the stepped protruding portion 40 and the first interfitting portion 25E.

The plate member 15G is held in a curved state so as to be placed in close contact with the mounting surface 4a by pressing forces from holders 11A.

A procedure for assembling the waveguide structure 1L is similar to that of Embodiment 1 except that the first divided plate member 16g is disposed on the mounting surface 4a such that the first notch 31b is fitted together with the first step portion 40a, and the second divided plate member 22f id disposed on the first divided plate member 16g such that the third notch 33b is fitted together with the second step portion 40b.

In Embodiment 7, the stepped protruding portion 40 is constituted by a first step portion 40a and a second step portion 40b that are formed at predetermined height positions in the direction of projection from the mounting surface 4a so as to have a stepped shape such that a width in the sweep direction becomes narrower. A first notch 31b that corresponds to an external shape of the first step portion 40a when viewed from the direction of projection of the stepped protruding portion 40 from the mounting surface 4a is formed on the first divided plate member 16g, and a third notch 33b that corresponds to an external shape of the second step portion 40b when viewed from the direction of projection of the stepped protruding portion 40 from the mounting surface 4a is formed on the second divided plate member 22f.

Thus, even if an attempt is made to stack the first divided plate member 16g and the second divided plate member 22f onto the mounting surface 4a in an incorrect stacking sequence, the second divided plate member 22f cannot be fitted together with the first step portion 40a because area of the third notch 33b of the second divided plate member 22f is less than area of the first step portion 40a when viewed from the direction of projection of the stepped protruding portion 40 from the mounting surface 4a.

In other words, the stepped protruding portion 40 also functions as the first positioning pin 10a and the second positioning pin 10b according to the waveguide structure 1A, and fulfills a role of positioning the first divided plate member 16g and the second divided plate member 22f at a prescribed position on the mounting surface 4a and a role of preventing errors in stacking sequence. Consequently, according to the waveguide structure 1L, effects can be achieved such as preventing the first divided plate member 16g and the second divided plate member 22f from being stacked on the mounting surface 4a in an incorrect stacking sequence in addition to the effects of Embodiment 1.

Moreover, in Embodiment 7, the plate member 15G is explained as being constituted by a two divided plate members that are constituted by the first divided plate member 16g and the second divided plate member 22f, and the stepped protruding portion 40 as being configured so as to have two steps. However, the number of steps in the stepped protruding portion 40 should be appropriately determined so as to correspond to the number of stacked plates in the divided plate members that constitute the plate member.

In other words, if a plate member is constituted by n divided plate members (where n is an integer that is greater than or equal to 2) that are stacked on the mounting surface 4a of the base 2A, the stepped protruding portion 40 may also be configured by integrating first through n-th step portions that have areas of cross sections that are perpendicular to a thickness direction that are reduced sequentially. The stepped protruding portion should be disposed so as to protrude from the mounting surface 4a such that a first step portion is positioned near the mounting surface 4a and a thickness direction is aligned in a direction of projection. Here, heights of the m-th step portion of the stepped protruding portion (where m is an integer that is greater than or equal to 1 and less than or equal to n) from the mounting surface 4a are configured so as to reach a height that corresponds to each of the number of stacked divided plate members from one plate to m plates. Notches or interfitting apertures that function as stacking sequence regulating interfitting portions that have sizes that correspond to sizes of the cross-sectional areas that are perpendicular to the thickness direction of the m-th step portion should be formed on divided plate members that are stacked on the mounting surface 4a up to an m-th layer. Divided plate members that fit together with each of the step portions of the stepped protruding portion are thereby also determined uniquely, preventing the plurality of divided plate members from being stacked in an incorrect stacking sequence.

Moreover, the stepped protruding portion 40 may also be configured without omitting the positioning pin 10a and the positioning pin 10b by coaxially integrating first through (n−1)-th step portions that have areas of cross sections that are perpendicular to a thickness direction that are reduced sequentially. In that case, the stepped protruding portion should also be disposed so as to protrude from the mounting surface 4a such that a first step portion is positioned near the mounting surface 4a and a thickness direction is aligned in a direction of projection. Interfitting apertures that function as stacking sequence regulating intermitting portions that have sizes that correspond to sizes of the cross-sectional areas that are perpendicular to the thickness direction of the m-th step portion should be formed on divided plate members that are stacked on the mounting surface 4a up to an m-th layer, where m is an integer that is greater than or equal to 1 and less than or equal to (n−1). Divided plate members that fit together with each of the step portions of the stepped protruding portion are also determined uniquely when configured in this manner, preventing the plurality of divided plate members from being stacked in an incorrect stacking sequence.

However, when the stepped protruding portion 40 also functions as the first positioning pin 10a and the second positioning pin 10b according to the waveguide structure 1A, the waveguide structure can be simplified and reduced in size compared to when members for positioning the plate member 15G at the prescribed position on the mounting surface 4a and for preventing stacking sequence errors are configured separately, thereby enabling reductions in the cost of the waveguide structure to be achieved.

### Embodiment 8

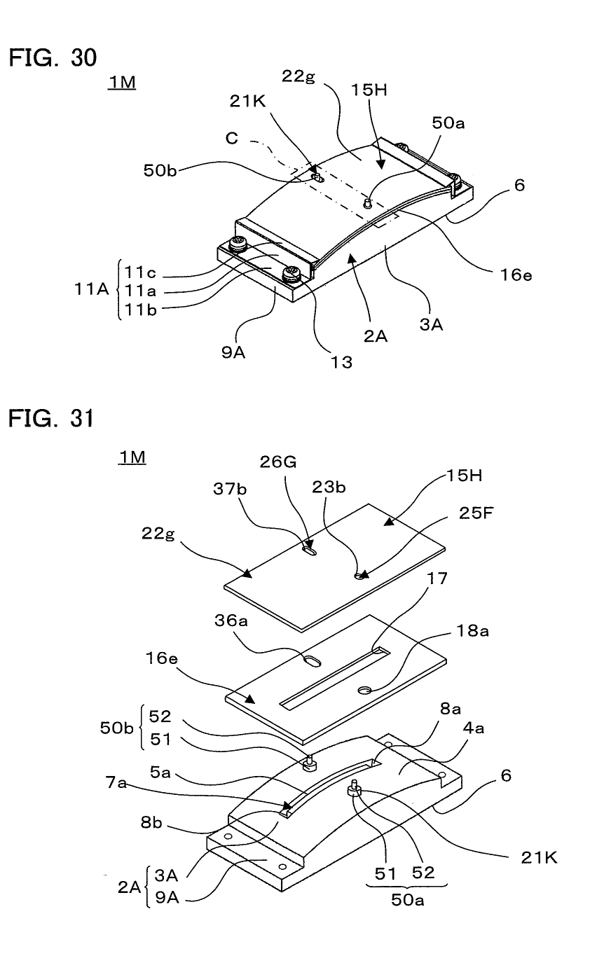

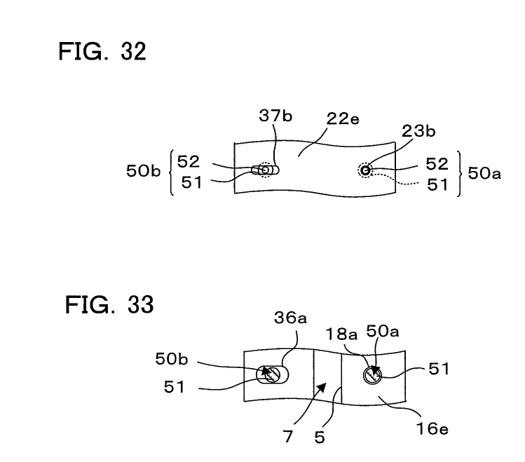

FIG. 30 is a perspective of a waveguide structure according to Embodiment 8 of the present invention, FIG. 31 is an exploded perspective of the waveguide structure according to Embodiment 8 of the present invention, FIG. 32 is an enlarged front elevation of Portion C in FIG. 30, and FIG. 33 is a front elevation that does not consider a second plate member from FIG. 32.

Moreover, in FIGS. 30 through 33, portions identical to or corresponding to those in Embodiment 1 above will be given identical numbering, and explanation thereof will be omitted.

In FIGS. 30 through 33, a waveguide structure 1M is configured in a similar manner to Embodiment 1 above except that a first multiple diameter pin 50a and a second multiple diameter pin 50b that function as a positioning member and a stacking sequence regulating member are disposed so as to project from the mounting surface 4a instead of the first positioning pin 10a and the second positioning pin 10b, a plate member 15H is used instead of the plate member 15A, and the first positioning pin 10a and the second positioning pin 10b are omitted.

Specifically, the first multiple diameter pin 50a and the second multiple diameter pin 50b are each disposed so as to be separated from each other so as to project from a mounting surface maximum projecting portion so as to be separated by a first distance from two edge portions that are parallel to the curve direction.

The first multiple diameter pin 50a and the second multiple diameter pin 50b are each constituted by a first step portion 51 and a second step portion 52 that have a circular cross sectional shape that are integrated coaxially. Here, a thickness direction of each of the step portions is an axial direction. A diameter of the second step portion 52 is smaller than a diameter of the first step portion 51. The first multiple diameter pin 50a and the second multiple diameter pin 50b are disposed so as to protrude from the mounting surface 4a such that the first step portion 51 is positioned near the mounting surface 4a and the thickness direction is aligned in a direction of projection from the mounting surface 4a.

The plate member 15H includes: a first divided plate member 16e that is stacked on a mounting surface 4a; and a second divided plate member 22g that is stacked on the first divided plate member 16e.

A diameter of the first interfitting aperture 18a and a minor axial length of the second interfitting aperture 36a of the first divided plate member 16e are slightly longer than diameters of the first step portions 51 of the first multiple diameter pin 50a and the second multiple diameter pin 50b.

The second divided plate member 22g is similar in configuration to the second divided plate member 22e of the waveguide structure 1I except that a third interfitting aperture 23b is formed instead of the third interfitting aperture 23a, and a slot-shaped fourth interfitting aperture 37b is formed instead of the fourth interfitting aperture 37a.

Moreover, a major axis of the fourth interfitting aperture 37b is oriented in a width direction of the first divided plate member 16e and the second divided plate member 22g.

A diameter of the third interfitting aperture 23b is slightly larger than a diameter of the second step portion 52 of the first multiple diameter pin 50a, and a minor axial length of the fourth interfitting aperture 37b is slightly longer than a diameter of the second step portions 52 of the second multiple diameter pin 50b.

A major axial length of the fourth interfitting aperture 37b is determined in a similar manner to the second interfitting aperture 36a of the waveguide structure 1I with consideration for an amount of permissible drift in the distance between the first interfitting aperture 18a and the second interfitting aperture 36a from a design perspective, an amount of permissible drift in the distance between the third interfitting aperture 23b and the fourth interfitting aperture 37b from a design perspective, an amount of relative drift in the first divided plate member 16e and the second divided plate member 22g relative to each of the multiple diameter pins 50a and 50b allowing for age-related changes, and an amount of relative drift in the first divided plate member 16e and the second divided plate member 22g relative to each of the multiple diameter pins 50a and 50b allowing for differences in coefficient of linear expansion if the first divided plate member 16e and the second divided plate member 22g are constituted by different metals.

The first divided plate member 16e is stacked on the mounting surface 4a such that a first surface thereof faces the mounting surface 4a in a state in which the first step portion 51 of the first multiple diameter pin 50a and the first step portion 51 of the second multiple diameter pin 50b are inserted through the first interfitting aperture 18a and the second interfitting aperture 36a. In addition, the second divided plate member 22g is stacked on the first divided plate member 16e such that a first surface thereof faces the first divided plate member 16e in a state in which the second step portion 52 of the first multiple diameter pin 50a and the second step portion 52 of the second multiple diameter pin 50b are inserted through the third interfitting aperture 23b and the fourth interfitting aperture 37b.

A positioning mechanism 21K is constituted by the first multiple diameter pin 50a, the second multiple diameter pin 50b, the first interfitting portion 25F, which is constituted by the first interfitting aperture 18a and the third interfitting aperture 23b that functions respectively as a stacking sequence regulating interfitting portion, and the second interfitting portion 26G, which is constituted by the second interfitting aperture 36a and the fourth interfitting aperture 37b that functions respectively as a stacking sequence regulating interfitting portion. Here, because gaps between the first interfitting aperture 18a and the first multiple diameter pin 50a and between the second interfitting aperture 23b and the first multiple diameter pin 50a are practically nonexistent, movement of the first divided plate member 16e and the second divided plate member 22g is restricted other than in the circumferential direction and the axial direction of the first multiple diameter pin 50a. In addition, because gaps between wall portions on two minor axial sides of the second interfitting aperture 36a and the fourth interfitting aperture 37b and the first step portion 51 and the second step portion 52 of the second multiple diameter pin 50b are practically nonexistent, movement of the first divided plate member 16e and the second divided plate member 22g is also restricted in the circumferential direction of the first multiple diameter pin 50a.

In other words, the positioning mechanism 21K positions the plate member 15H at a prescribed position on the mounting surface 4a and also restricts movement of the plate member 15H parallel to the mounting surface 4a by the fitting together of the first multiple diameter pin 50a and the first interfitting portion 25F, and by the fitting together of the second multiple diameter pin 50b and the second interfitting portion 26G.

The plate member 15H is held in a curved state so as to be placed in close contact with the mounting surface 4a by pressing forces from holders 11A.

Immediately after assembly of the waveguide structure 1M, predetermined gaps or greater are formed between the second interfitting aperture 36a and the second multiple diameter pin 50b and between the fourth interfitting aperture 37b and the second multiple diameter pin 50b on the major axis of the second interfitting aperture 36a and the fourth interfitting aperture 37b. Large stresses can thereby be prevented from arising between the second multiple diameter pin 50b and the first divided plate member 16e and between the second multiple diameter pin 50b and the second divided plate member 22g even if relative drift arises between the second multiple diameter pin 50b and the first divided plate member 16e and between the second multiple diameter pin 50b and the second divided plate member 22g as a result of permissible errors during machining, differences in coefficient of linear expansion between the members, and age-related changes.

Moreover, because the second interfitting aperture 36a and the fourth interfitting aperture 37b need only restrict rotation of the first divided plate member 16e and the second divided plate member 22g around an axis of the first multiple diameter pin 50a, major axial length precision is not particularly required provided that management of minor axial length precision is performed.

A procedure for assembling the waveguide structure 1M is similar to that of Embodiment 1 except that the first divided plate member 16c and the second divided plate member 22g are stacked on the mounting surface 4a such that the first interfitting aperture 18a and the third interfitting aperture 23b are aligned with the first multiple diameter pin 50a, and the second interfitting aperture 36a and the fourth interfitting aperture 37b are aligned with the second multiple diameter pin 50b.

According to Embodiment 8, the first divided plate member 16e and the second divided plate member 22g can be disposed accurately at a prescribed position on the mounting surface 4a in a similar manner to Embodiment 1 simply by inserting the first multiple diameter pin 50a and the second multiple diameter pin 50b through the first interfitting aperture 18a and the second interfitting aperture 36a, and through the third interfitting aperture 23b and the fourth interfitting aperture 37b, when disposing the first divided plate member 16e and the second divided plate member 22g on the mounting surface 4a.

The first multiple diameter pin 50a and the second multiple diameter pin 50b are disposed so as to project from the mounting surface 4a such that diameters reduce in a stepped shape at a position of the thickness of the first divided plate member 16e in the direction of projection from the mounting surface 4a. In addition, a first interfitting aperture 18a that has a diameter that corresponds to the diameter of the first step portion 51 of the first multiple diameter pin 50a and a slot-shaped second interfitting aperture 36a that has a minor axial length that corresponds to the diameter of the first step portion 51 of the second multiple diameter pin 50b are formed on the first divided plate member 16e. A third interfitting aperture 23b that has a diameter that corresponds to the diameter of the second step portion 52 of the first multiple diameter pin 50a and a slot-shaped fourth interfitting aperture 37b that has a minor axial length that corresponds to the diameter of the second step portion 52 of the second multiple diameter pin 50b are formed on the second divided plate member 22g.

Thus, even if an attempt is made to stack the first divided plate member 16e and the second divided plate member 22g onto the mounting surface 4a in an incorrect stacking sequence, the first multiple diameter pin 50a and the second multiple diameter pin 50b cannot be inserted through the third intermitting aperture 23b and the fourth interfitting aperture 37b of the second divided plate member 22g. Consequently, according to the waveguide structure 1M, effects can be achieved such as preventing the first divided plate member 16e and the second divided plate member 22g from being stacked on the mounting surface 4a in an incorrect stacking sequence in addition to the effects of Embodiment 1.

Thus, the first multiple diameter pin 50a and the second multiple diameter pin 50b also function as the first positioning pin 10a and the second positioning pin 10b according to the waveguide structure 1A, and fulfill a role of positioning the plate member 15H that is constituted by the first divided plate member 16e and the second divided plate member 22g at a prescribed position on the mounting surface 4a and a role of preventing errors in stacking sequence. In other words, the waveguide structure can be simplified and reduced in size compared to when members for positioning the plate member 15H at the prescribed position on the mounting surface 4a and for preventing stacking sequence errors are configured separately, thereby enabling reductions in the cost of the waveguide structure to be achieved.

Moreover, in Embodiment 8, the plate member 15H is explained as being constituted by two plates, i.e., the first divided plate member 16e and the second divided plate member 22g, and the first multiple diameter pin 50a and the second multiple diameter pin 50b as being each configured so as to have two steps, i.e., the first step portion 51 and the second step portion 52. However, the number of steps in the first multiple diameter pin 50a and the second multiple diameter pin 50b should be appropriately determined so as to correspond to the number of stacked plates in the divided plate members that constitute the plate member.

In other words, if a plate member is constituted by n divided plate members (where n is an integer that is greater than or equal to 2) that are stacked on the mounting surface 4a of the base 2A, multiple diameter pins may also be configured by coaxially integrating first through n-th step portions that have areas of cross sections (or diameters) that are perpendicular to a thickness direction (an axial direction) that are reduced sequentially. Here, heights of the m-th step portion of the multiple diameter pins (where m is an integer that is greater than or equal to 1 and less than or equal to n) from the mounting surface 4a should be configured to a height that corresponds to each of the number of stacked divided plate members from one plate to m plates. Interfitting apertures that function as stacking sequence regulating interfitting portions that have sizes that correspond to sizes of the cross-sectional areas that are perpendicular to the axial direction of the m-th step portion should be formed on divided plate members that are stacked on the mounting surface 4a up to an m-th layer.

If a multiple diameter pin is disposed separately from the first positioning pin 10a and the second positioning pin 10b, the multiple diameter pin may also be configured by coaxially integrating first through (n−1)-th step portions.

The second multiple diameter pin 50b is explained as being inserted through the second interfitting aperture 36a and the fourth interfitting aperture 37b, but a second positioning pin 10b that has a single diameter that spans an axial direction may also be disposed so as to protrude from the mounting surface 4a instead of the second multiple diameter pin 50b. In that case, a minor axial length of a first slot on a first divided plate member and a minor axial length of a second slot on a second divided plate member should be formed so as to correspond to the diameter of the second positioning pin 10b. The above effects can also be achieved by a waveguide structure that is configured in this manner.

The above effects can also be achieved by a waveguide structure that is configured by forming notches on the first plate member and the second plate member instead of the respective first interfitting aperture 18a, third intermitting aperture 23b, second interfitting aperture 36a, and fourth interfitting aperture 37b.

### Embodiment 9

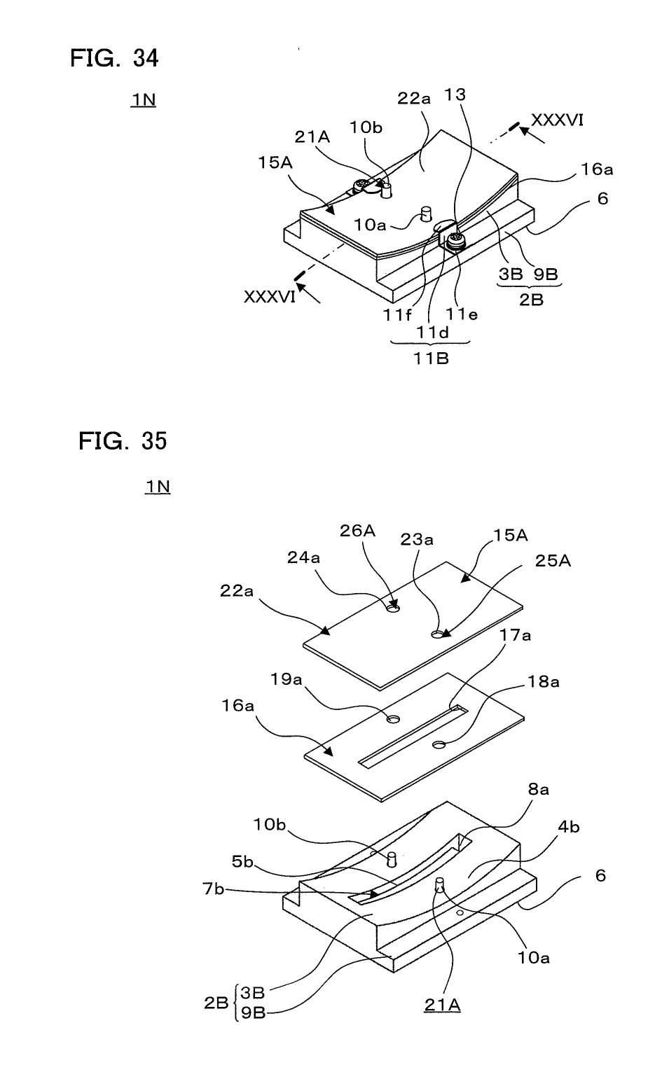

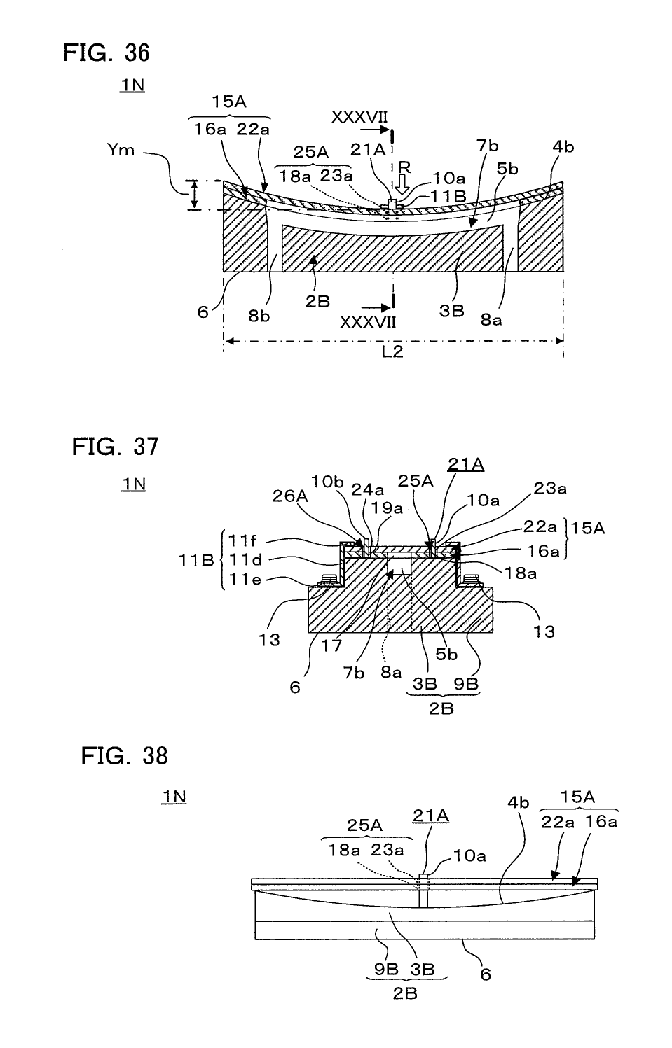

FIG. 34 is a perspective of a waveguide structure according to Embodiment 9 of the present invention, FIG. 35 is an exploded perspective of the waveguide structure according to Embodiment 9 of the present invention, FIG. 36 is a cross section taken along Line XXXVI-XXXVI in FIG. 34 viewed from the direction of the arrows, FIG. 37 is a cross section taken along Line XXXVII-XXXVII in FIG. 36 viewed from the direction of the arrows, and FIG. 38 is a diagram for explaining a procedure for assembling the waveguide structure of the invention according to Embodiment 9 of the present invention.

Moreover, depiction of holders is omitted in FIG. 35.

In FIGS. 34 through 38, portions identical to or corresponding to those in Embodiment 1 above will be given identical numbering, and explanation thereof will be omitted.

In FIGS. 34 through 37, a waveguide structure 1N is configured in a similar manner to Embodiment 1 above except that a base 2B is used instead of the base 2A, and a pair of holders 11B that function as a holding means are used instead of the pair of holders 11A.

The base 2B is prepared using a metal, and is constituted by: a metal main body portion 3B that has a curved mounting surface 4b; and flanges 9B that project out from two ends of the main body portion 3B in the width direction. The main body portion 3B has a rectangular shape when viewed from a side that is opposite the mounting surface 4b, and hereinafter a longitudinal direction of the main body portion 3B when the main body portion 3B is viewed from the side that is opposite the mounting surface 4b will simply be called the longitudinal direction of the main body portion 3B.

The mounting surface 4b is configured so as to have a concave curved surface that is obtained by sweeping a cantilever deflection curve in a sweep direction. Moreover, the sweep direction is a direction that is perpendicular to a plane that includes the deflection curve.

The cantilever deflection curve is set as follows:

a central portion in the longitudinal direction of the plate member 15A is supported and the plate member 15A is deflected by applying a load to two longitudinal edges. The cantilever deflection curve is set so as to be a curve that is parallel to major surfaces of the plate member 15A in a cross section that is perpendicular to the width direction of the plate member 15A in this state. Moreover, if it is necessary to make the pressure distribution between the plate member 15A and the base 2A uniform when the plate member 15A is deflected parallel to the mounting surface 4a by pressing the central portion of the plate member 15A, it is desirable for the cantilever deflection curve to be a shape that applies a uniformly distributed load over an entire region in the longitudinal direction of the plate member 15A.

The mounting surface 4b is formed so as to have a curve in the cross section of the main body portion 3B that is perpendicular to the sweep direction in which a distance from a line segment that connects two ends of the mounting surface 4b increases toward center in the curve direction, as shown in FIG. 36. In other words, the distance from a plane that includes the two edge portions of the mounting surface 4b in the curve direction increases toward a longitudinal center in the curve direction of the mounting surface 4b.

A waveguide groove 5b that has an opening on the mounting surface 4b is formed on the main body portion 3B. Here, the waveguide groove 5b extends for a predetermined length in the longitudinal direction of the main body portion 3B at a predetermined depth and a predetermined width in the sweep direction of the mounting surface 4b.

Waveguide input and output passages 8a and 8b are each formed on the main body portion 3B so as to pass through between an input and output port forming surface 6 that is configured on an opposite side from the mounting surface 4b and each of two ends of the waveguide groove 5b.

Hereinafter, the portion of the mounting surface 4b at which the distance from the plane that includes the two edge portions of the mounting surface 4b in the curve direction is greatest will be called “a mounting surface maximum recess portion”.

The pair of holders 11B are each configured by bending two ends of flat plates, and are constituted by: an intermediate portion 11d; and a mounted portion 11e and a pressing portion 11f that extend outward from the intermediate portion 11d in opposite directions.

A first positioning pin 10a and a second positioning pin 10b are disposed so as to protrude at the mounting surface maximum recess portion on two sides of the waveguide groove 5b in the sweep direction. The first positioning pin 10a and the second positioning pin 10b are formed at portions that are separated by a first distance from each of two edge portions in the sweep direction of the mounting surface 4b.

A first divided plate member 16a is stacked on the mounting surface 4b such that a first surface thereof faces the mounting surface 4b in a state in which the first positioning pin 10a and the second positioning pin 10b are inserted through a first interfitting aperture 18a and a second interfitting aperture 19a. Here, a waveguide constituting aperture 17 faces the waveguide groove 5b.

In addition, the second divided plate member 22a is stacked on the first divided plate member 16a such that a first surface thereof faces a second surface of the first divided plate member 16a in a state in which the first positioning pin 10a and the second positioning pin 10b are inserted through the third interfitting aperture 23a and the fourth interfitting aperture 24a. In other words, a positioning mechanism 21A is disposed so as to be positioned at the mounting surface maximum recess portion. The positioning mechanism 21A positions the plate member 15A at a prescribed position on the mounting surface 4b and also restricts movement of the plate member 15A parallel to the mounting surface 4b by the fitting together of the first positioning pin 10a and the first interfitting portion 25A, and by the fitting together of the second positioning pin 10b and the second interfitting portion 26A.

The mounted portion 11e of a first holder 11B is securely fastened onto a longitudinally central portion of a first flange 9B by a screw 13. Here, the intermediate portion 11d of the holder 11A extends so as to be opposite side surfaces of the first divided plate member 16a and the second divided plate member 22a, and such that the pressing portion 11f presses a vicinity of a central portion a first edge portion of the second divided plate member 22a in the sweep direction.

The mounted portion 11e of a second holder 11B is also securely fastened onto a longitudinally central portion of a second flange 9B by a screw 13. Here, the intermediate portion 11d of the holder 11A extends so as to be opposite side surfaces of the first divided plate member 16a and the second divided plate member 22a, and such that the pressing portion 11f presses a vicinity of a central portion a second edge portion of the second divided plate member 22a in the sweep direction.

The first divided plate member 16a and the second divided plate member 22a are held stably on the mounting surface 4b in a curved state parallel to the mounting surface 4b by pressing forces from the holders 11B.

The waveguide groove 5b, the waveguide constituting aperture 17, and the second divided plate member 22a function together to constitute a waveguide 7b that extends in the longitudinal direction of the main body portion 3B.

Here, the pressing portions 11f of the holders 11B are configured so as to have a curved shape equal to the curved shape of the portion of the second divided plate member 22a that contacts the pressing portion 11f so as not to impede curvature of the plate member 15A. Moreover, the pressing portions 11f may also press the second divided plate member 22a in point contact with the second divided plate member 22a.

Moreover, the shape of the deflection curve of the mounting surface 4b, in other words, the shape of the curve due to the path that is drawn in the curve direction of the mounting surface 4b, is configured so as to satisfy Expression (3) below, and the holders 11B are configured so as to press the central portions of each of the edge portions of the second divided plate member 22a in the sweep direction with a pressing force R that can be expressed by Expression (4) below.

Moreover, Expression (3) is a deflection curve formula from material mechanics for a cantilever that is subjected to a uniformly distributed load along its entire length, and Expression (4) is an expression that is easily found from a maximum deflection formula and a geometrical-moment of inertia formula for a plate.

Y=16YmX(X4−L23X/2+3L24/16)/(3L24) (3)

R=2kEbh3Ym/(3L23) (4)

Here, a Y-axis direction is a normal direction of a plane that includes the edge portions of the mounting surface 4b at the two ends in the curve direction, and an X-axis direction is a direction in which the edge portions of the mounting surface 4b at the two ends in the curve direction face each other.

Point 0 of the Y-axis and X-axis is the mounting surface maximum recess portion of the base 2B.

Ym, L2, E, b, h, and k are defined as follows:

Ym is maximum deflection of the second divided plate member 22a, which is defined by a maximum distance between the second divided plate member 22 and a plane that includes edge portions at two ends of a front surface (a second surface) of the second divided plate member 22a in the curve direction;

L2 is spacing between two ends of the plate member 15A in the curve direction;

E is a modulus of longitudinal elasticity of the first divided plate member 16a and the second divided plate member 22a

b is a length of the first divided plate member 16a and the second divided plate member 22a in the sweep direction;

h is a total thickness of the first divided plate member 16a and the second divided plate member 22a; and

k is the number of divided plate members that constitute the plate member 15A.

When the two edge portions in the curve direction of the first divided plate member 16a and the second divided plate member 22a are each pressed with a pressing force that has a predetermined value R that is defined by Expression (3), reaction forces that act in a direction in which an entire region of the first divided plate member 16a and the second divided plate member 22a are pressed against the mounting surface 4b arise in the first divided plate member 16a and the second divided plate member 22a.

In other words, the first divided plate member 16a is stacked onto the mounting surface 4b without forming gaps between it and the mounting surface 4b, and the second divided plate member 22a is stacked onto the first divided plate member 16a without forming gaps between it and the first divided plate member 16a.

Stable electrical continuity is thereby ensured between the first divided plate member 16a and the main body portion 3B, and between the first divided plate member 16a and the second divided plate member 22a.

Next, a procedure for assembling the waveguide structure 1N will be explained.

First, the first divided plate member 16a is mounted on the mounting surface 4b by inserting the first positioning pin 10a and the second positioning pin 10b through the first interfitting aperture 18a and the second interfitting aperture 19a of the first divided plate member 16a, as shown in FIG. 38. Next, the second divided plate member 22a is mounted on the first divided plate member 16a by inserting the first positioning pin 10a and the second positioning pin 10b through the third interfitting aperture 23a and the fourth interfitting aperture 24a of the second divided plate member 22a.

The first divided plate member 16a and the second divided plate member 22a are then deformed elastically so as to lie alongside the mounting surface 4b. Next, as shown in FIGS. 34 and 37, portions of the first divided plate member 16a on two sides of the mounting surface maximum recess portion in the sweep direction are pressed down by the pressing portions 11f while maintaining elastic deformation by fastening the mounted portions 11e of each of the pair of holders 11B into the respective pair of flanges 9B using the screws 13. Assembly of the waveguide structure 1N is thereby completed.

The waveguide structure 1N according to Embodiment 9 includes: a metal base 2B that has a mounting surface 4b that is configured so as to have a curved surface that is obtained by sweeping in a sweep direction a deflection curve for a cantilever; and an elastic metal plate member 15A that is stacked on the mounting surface 4b and that functions together with the base 2B to constitute a waveguide 7b. In addition, the waveguide structure 1N includes holders 11B that press intermediate portions of each of two edge portions in the sweep direction of the plate member 15A that has been stacked on the mounting surface 4b so as to generate reaction forces in the plate member 15A to hold the plate member 15A on the mounting surface 4b in a state of close contact.

The waveguide structure 1N also includes a positioning mechanism 21A that positions the plate member 15A on the mounting surface 4b and also restricts movement of the plate member 15A parallel to the mounting surface 4b by the fitting together of the first positioning pin 10a and the second positioning pin 10b with the first interfitting portion 25A and the second interfitting portion 26A.

Consequently, according to the waveguide structure 1N, similar effects to those of the waveguide structure 1A can be achieved.

### Embodiment 10

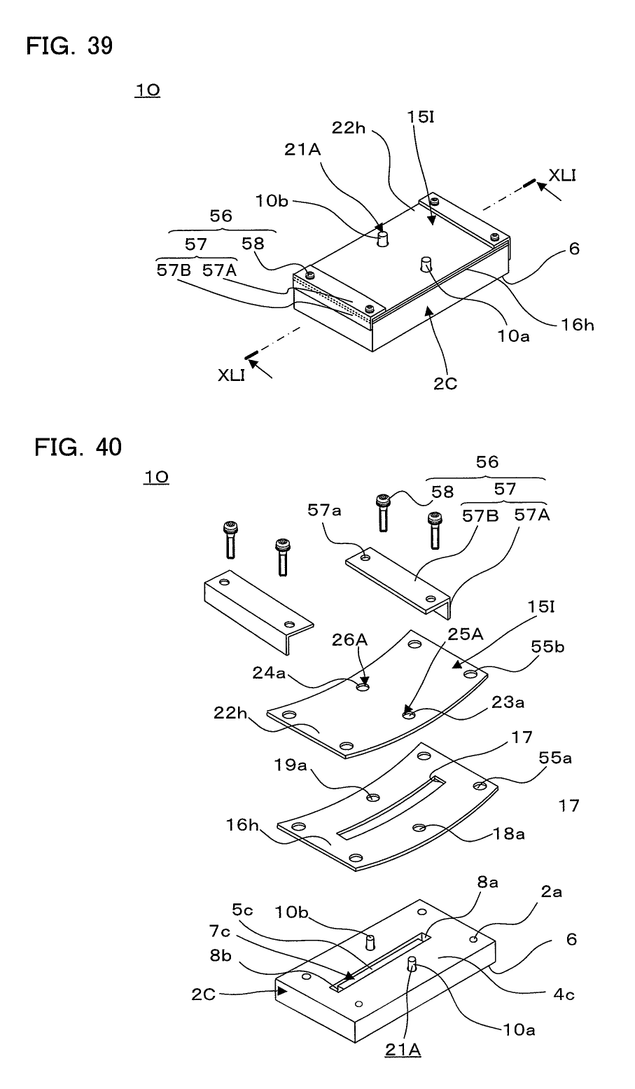

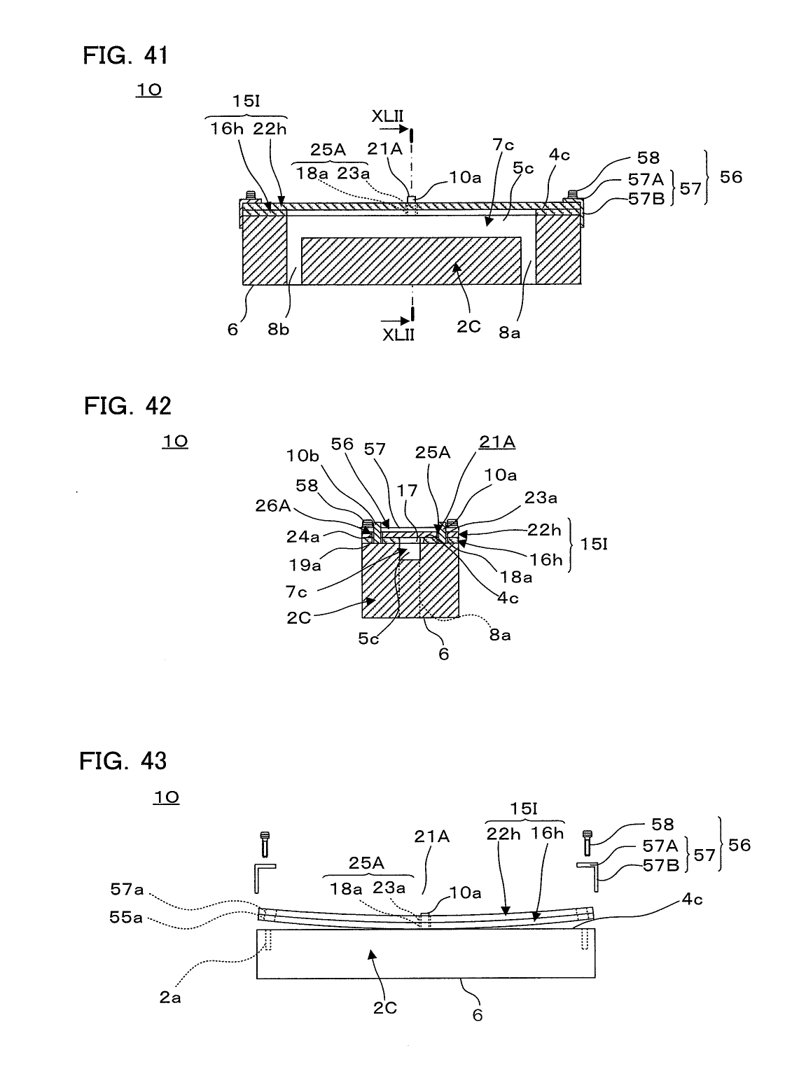

FIG. 39 is a perspective of a waveguide structure according to Embodiment 10 of the present invention, FIG. 40 is an exploded perspective of the waveguide structure according to Embodiment 10 of the present invention, FIG. 41 is a cross section taken along Line XLI-XLI in FIG. 39 viewed from the direction of the arrows, FIG. 42 is a cross section taken along Line XLII-XLII in FIG. 41 viewed from the direction of the arrows, and FIG. 43 is a diagram for explaining a procedure for assembling the waveguide structure of the invention according to Embodiment 10 of the present invention.

In FIGS. 39 through 42, a waveguide structure 1O includes: a metal base 2C that has a flat mounting surface 4c; and an elastic metal plate member 15I that is stacked on the mounting surface 4c and that functions together with the base 2C to constitute a waveguide 7c. In addition, the waveguide structure 1O includes: a positioning mechanism 21A that is constituted by: a first positioning pin 10a and a second positioning pin 10b that are disposed so as to protrude from the mounting surface 4c; and a first interfitting portion 25A and a second interfitting portion 26A that are formed on the plate member 15I and that are fitted together with the first positioning pin 10a and the second positioning pin 10b, the positioning mechanism 21A positioning the plate member 15I on the mounting surface 4c, and also restricting movement parallel to the mounting surface 4c; and a plate member holding jig 56 that functions as a holding means that elastically deforms a first divided plate member 16h and a second divided plate member 22h into a flat shape and holds them on the mounting surface 4c in a state of close contact.

The base 2C is configured so as to have a rectangular parallelepipedic shape, and the mounting surface 4c is configured on a first surface thereof.

A waveguide groove 5c that has an opening on the mounting surface 4c is formed on the base 2C. Here, the waveguide groove 5c extends for a predetermined length in the longitudinal direction of the mounting surface 4c at a predetermined width and a predetermined depth in the sweep direction of the mounting surface 4c. Screw-threaded apertures 2a are also formed on the base 2C so as to have openings in a vicinity of each of the corner portions of the mounting surface 4c.

Waveguide input and output passages 8a and 8b are each formed on the base 2C so as to pass through between an input and output port forming surface 6 that is configured on an opposite side from the mounting surface 4c of the base 2C and each of two ends of the waveguide groove 5c.

A first positioning pin 10a and a second positioning pin 10b are disposed so as to protrude from two sides of the waveguide groove 5c in the width direction of the mounting surface 4c at a central portion in the longitudinal direction of the mounting surface 4c. Here, the first positioning pin 10a and the second positioning pin 10b are formed at portions that are separated by a predetermined distance from each of the long sides of the mounting surface 4c.

The plate member 15I is constituted by a two-layer divided plate member that is made up of: a first divided plate member 16h that is stacked on the mounting surface 4c; and a second divided plate member 22h that is stacked on the first divided plate member 16h. The first divided plate member 16h and the second divided plate member 22h are constituted by similar elastic metals.

The first divided plate member 16h is elastic, and is configured by curving a rectangular flat plate that has long sides that match a length of a long side of the mounting surface 4c, and short sides that match a length of the mounting surface 4c in the width direction. A major surface of the first divided plate member 16h is configured into a curved surface that is obtained by sweeping a deflection curve for a beam supported at two ends in the sweep direction. In other words, two surfaces of the first divided plate member 16h are constituted by a concave surface and a convex surface.

The sweep direction of the first divided plate member 16h is a direction that is perpendicular to the plane that includes the deflection curve, and the first divided plate member 16h does not have curvature over an entire region in the sweep direction. A direction that is parallel to the deflection curve for a beam supported at two ends of the major surfaces in the cross section of the first divided plate member 16h that is perpendicular to the sweep direction will be called “the curve direction”.

An first interfitting aperture 18a and a second interfitting aperture 19a are respectively formed on portions of the first divided plate member 16h that are longitudinally central in the curve direction, and that are separated by a predetermined distance from each edge portions that are oriented in the curve direction. A waveguide constituting aperture 17 is formed on the first divided plate member 16h so as to face the waveguide groove 5c when the first divided plate member 16h and the mounting surface 4c are placed in close contact with outer edges aligned.

Penetrating aperture 55a are formed in a vicinity of each of the corner portions of the first divided plate member 16h.

The second divided plate member 22h is similarly configured by curving a rectangular flat plate that is identical in size to the first divided plate member 16h. A third interfitting aperture 23a and a fourth interfitting aperture 24a are respectively formed on portions of the second divided plate member 22h that are longitudinally central in the curve direction, and that are separated by a predetermined distance from each edge portions that are oriented in the curve direction.

Penetrating aperture 55b are respectively formed in a vicinity of the corner portions of the second divided plate member 22h.

Moreover, aperture diameters of the penetrating aperture 55a and 55b are greater than aperture diameters of the screw-threaded apertures 2a.

The plate member holding jigs 56 have pressing force transmitting covers 57 and plate member pressing screws 58.

The pressing force transmitting covers 57 are formed so as to have L-shaped cross sections that are constituted by a flat, rectangular plate member pressing portion 57A, and an auxiliary projecting portion 57B that extends vertically outward from one of the long sides of the plate member pressing portion 57A. A pair of penetrating apertures 57a are formed on the plate member pressing portion 57A so as to be separated from each other in a longitudinal direction.

The first divided plate member 16h and the second divided plate member are stacked on the mounting surface 4c by inserting the first positioning pin 10a and the second positioning pin 10b through the first interfitting aperture 18a and the second interfitting aperture 19a of the first divided plate member 16h, and inserting the first positioning pin 10a and the second positioning pin 10b through the third interfitting aperture 23a and the fourth interfitting aperture 24a of the second divided plate member 22h.

The positioning mechanism 21A is constituted by the first positioning pin 10a, the second positioning pin 10b, the first interfitting portion 25A, which is constituted by the first interfitting aperture 18a and the third interfitting aperture 23a, and the second interfitting portion 26A, which is constituted by the second interfitting aperture 19a and the fourth interfitting aperture 24a. In other words, the positioning mechanism 21A positions the plate member 15I at a prescribed position on the mounting surface 4c and also restricts movement of the plate member 15I parallel to the mounting surface 4c by the fitting together of the first positioning pin 10a and the first interfitting portion 25A, and by the fitting together of the second positioning pin 10b and the second interfitting portion 26A.

The pressing force transmitting covers 57 are disposed around two longitudinal edge portions of the mounting surface 4c. Here, the plate member pressing portions 57A are placed in contact with the mounting surface 4c such that the penetrating apertures 57a face the penetrating aperture 55a and 55b. Moreover, the auxiliary projecting portions 57B extend downward parallel to two end surfaces in the longitudinal direction of the base 2C of the laminated body that is constituted by the base 2C and the plate member 15I.

The first divided plate member 16h and the second divided plate member 22h are fastened to the base 2C by plate member pressing screws 58 that are inserted through the penetrating apertures 55a, 55b, and 57a and screwed into the screw-threaded aperture 2a. At that point, the first divided plate member 16h and the second divided plate member 22h are elastically deformed so as to have a flat shape so as to extend along the mounting surface 4c. Pressing force (fastening force) from the plate member pressing screws 58 is adjusted such that the second divided plate member 22h is pressed by a force that corresponds to the above Expression (2). Reaction forces that place the first divided plate member 16h in close contact with the mounting surface 4c and that place the second divided plate member 22h in close contact with the first divided plate member 16h are thereby generated by the pressing forces from the plate member pressing screws 58.

The waveguide groove 5c, the waveguide constituting aperture 17, and the second divided plate member 22h function together to constitute a waveguide 7c that extends in the longitudinal direction of the base 2C. Here, because the first divided plate member 16h and the mounting surface 4c, and the first divided plate member 16h and the second divided plate member 22h, are placed in close contact without leaving gaps, electrical continuity is ensured between the first divided plate member 16h and the second divided plate member 22h, and between the second divided plate member 22h and the base 2C.

Next, a procedure for assembling the waveguide structure 1O will be explained.

First, the first divided plate member 16h is mounted on the mounting surface 4c by placing the first divided plate member 16h opposite the mounting surface 4c such that the concave surface of the first divided plate member 16h faces away from the mounting surface 4c, and inserting the first positioning pin 10a and the second positioning pin 10b through the first interfitting aperture 18a and the second interfitting aperture 19a, as shown in FIG. 43.

Next, the second divided plate member 22h is mounted on the mounting surface 4c by placing the second divided plate member 22h opposite the first divided plate member 16h such that the concave surface of the second divided plate member 22h faces away from the mounting surface 4c, and inserting the first positioning pin 10a and the second positioning pin 10b through the third interfitting aperture 23a and the fourth interfitting aperture 24a.

The first divided plate member 16h and the second divided plate member 22h are then deformed elastically so as to have a flat shape. At that point, each of the screw-threaded apertures 2a in the vicinity of the corner portions of the base 2C, each of the penetrating apertures 55a in the vicinity of the corner portions of the first divided plate member 16h, and each of the penetrating apertures 55b in the vicinity of the corner portions of the second divided plate member 22h align with each other. The pressing force transmitting covers 57 are then disposed on the plate member 15I such that the auxiliary projecting portions 57B are parallel to two end surfaces of the first divided plate member 16h and the second divided plate member 22h in the longitudinal direction of the base 2C, and such that the penetrating apertures 57a of the plate member pressing portions 57A align with the penetrating aperture 55b. The plate member 15I is then fixed between the pressing force transmitting covers 57 and the base 2C by screwing the plate member pressing screws 58 that are inserted through the penetrating apertures 55a and 55b into the screw-threaded apertures 2a. Assembly of the waveguide structure 1O is thereby completed.

The waveguide structure 1O according to Embodiment 10 includes: a metal base 2C that has a flat mounting surface 4c; and a plate member 15I that is constituted by a first divided plate member 16h and a second divided plate member 22h that are each configured so as to have a curved plate shape using a metal that has elasticity, and that are stacked on the mounting surface 4c so as to be elastically deformed such that reaction forces are generated in a direction that presses against the mounting surface 4c, the plate member 15I functioning together with the base 2C to constitute a waveguide 7c.

The waveguide structure 1O also includes a positioning mechanism 21A that positions the plate member 15I on the mounting surface 4c and also restricts movement of the plate member 15I parallel to the mounting surface 4c by the fitting together of the first positioning pin 10a and the second positioning pin 10b with the first interfitting portion 25A and the second interfitting portion 26A. In addition, the waveguide structure 1O includes plate member holding jigs 56 that press two edge portions in the curve direction of the plate member 15I so as to generate reaction forces in the plate member 15I to hold the plate member 15I on the mounting surface 4c in a state of close contact.

Consequently, according to the waveguide structure 1O, similar effects to those of the waveguide structure 1A can be achieved.

Moreover, in Embodiment 10, the plate member 15I is explained as being configured by mounting a first divided plate member 16h and a second divided plate member 22h that have curved surfaces that are obtained by sweeping a deflection curve for a beam supported at two ends in the sweep direction onto a flat mounting surface 4c such that concave surfaces face away from the mounting surface 4c, then fixing first and second edge portions of the second divided plate member 16h in the curve direction onto the mounting surface 4c in a pressed state such that the first divided plate member 16h and the second divided plate member 22h are deformed elastically along the mounting surface 4c. However, stacking onto the mounting surface 4c of a first divided plate member and a second divided plate member that constitute a plate member is not limited to this state.

The plate member may also be configured as follows:

a first divided plate member and a second divided plate member are prepared that each have a curved surface that is obtained by sweeping front and rear surfaces in a cantilever deflection curve in the sweep direction. Then, the first divided plate member and the second divided plate member are mounted onto the mounting surface 4c such that the concave surfaces of each are oriented toward the mounting surface 4c, then the second divided plate member 16h is deformed elastically along the mounting surface 4c by pressing first and second sweep direction edge portions thereof.

### Embodiment 11

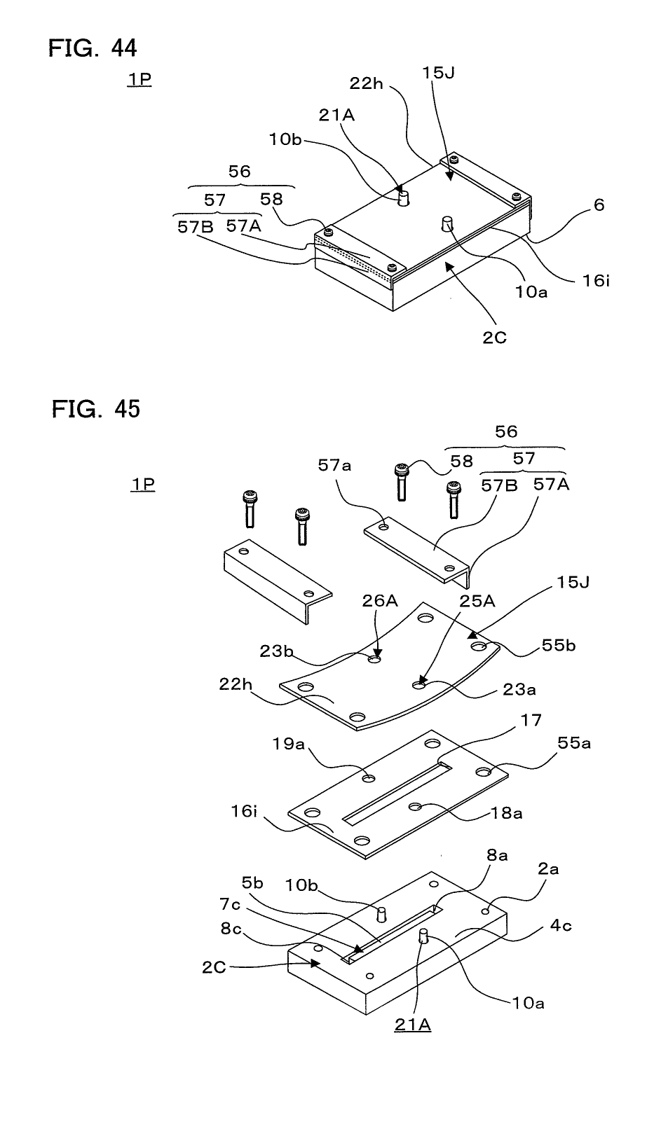

FIG. 44 is a perspective of a waveguide structure according to Embodiment 11 of the present invention, and FIG. 45 is an exploded perspective of the waveguide structure according to Embodiment 11 of the present invention.

Moreover, portions identical to or corresponding to those in Embodiments 1 and 10 above will be given identical numbering, and explanation thereof will be omitted.

In FIGS. 44 and 45, a waveguide structure 1P is configured in a similar manner to the waveguide structure 1O except that a plate member 15J is used instead of the plate member 15I.

The plate member 15J is configured in a similar manner to the plate member 15I except that a first divided plate member 16i that is stacked on a mounting surface 4c is used instead of the first divided plate member 16h.

The first divided plate member 16i is configured in a similar manner to the first divided plate member 16h except for being configured so as to have a flat, rectangular shape that has a major surface that is identical in the size the mounting surface 4c.

The first divided plate member 16i and the second divided plate member 22h are fastened to the base 2C by plate member pressing screws 58 that are inserted through the penetrating apertures 55a, 55b, and 57a, and the second divided plate member 22h is elastically deformed so as to be flat and extend along the mounting surface 4c.

Pressing force (fastening force) from the plate member pressing screws 58 is adjusted such that the second divided plate member 22h is pressed by a force that corresponds to the above Expression (2). Here, the first divided plate member 16i is placed in close contact with the mounting surface 4c and the second divided plate member 22h is placed in close contact with the first divided plate member 16i without gaps such that reaction forces are generated in the second divided plate member 22h due to the pressing forces from the plate member pressing screws 58.

A procedure for assembling the waveguide structure 1P is similar to the procedure for assembling the waveguide structure 1O except that the second divided plate member 22h is deformed elastically so as to contact the first divided plate member 16i flatly when being stacked on the mounting surface 4c instead of both the first divided plate member 16h and the second divided plate member 22h being deformed elastically so as to contact the mounting surface 4c flatly when being stacked on the mounting surface 4c.

The waveguide structure 1P according to Embodiment 11 also includes a positioning mechanism 21A that positions the plate member 15J on the mounting surface 4c and also restricts movement of the plate member 15J parallel to the mounting surface 4c by the fitting together of the first positioning pin 10a and the second positioning pin 10b with the first interfitting portion 25A and the second interfitting portion 26A.

In addition, the waveguide structure 1P includes plate member holding jigs 56 that press two edge portions in the curve direction of the second divided plate member 22a that constitutes the plate member 15J so as to generate reaction forces in the plate member 15J to hold the plate member 15J on the mounting surface 4c in a state of close contact.

Consequently, according to the waveguide structure 1P, similar effects to those of the waveguide structure 1A can be achieved.

Moreover, in Embodiments 10 and 11, the plate members 15I and 15J are explained as being held by the plate member holding jigs 56 in a state of close contact on the mounting surface 4c so as to generate reaction forces in the plate members 15I and 15J, but holders 11A may also be used instead of the plate member holding jigs 56 to hold the plate members 15I and 15J in a state of close contact on the mounting surface 4c so as to generate reaction forces in the plate members 15I and 15J.

### Embodiment 12

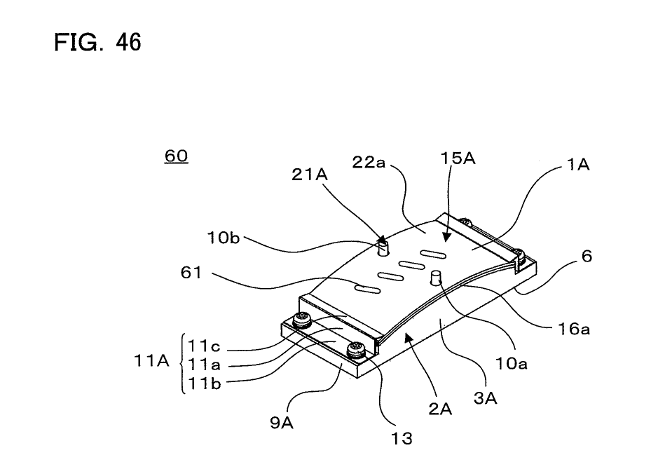

FIG. 46 is a perspective of a slot array antenna according to Embodiment 12 of the present invention.

In FIG. 46, portions identical to those in Embodiment 1 above will be given identical numbering, and explanation thereof will be omitted.

A slot array antenna 60 that functions as an antenna apparatus is configured by forming slits 61 for high frequency signal emission on a second divided plate member 22a on a waveguide structure 1A. A plurality of the slits 61 are formed in a direction of extension of a waveguide 7a so as to communicate between internal and external portions of the waveguide 7a.

In a slot array antenna 60 that uses the waveguide structure 1A, because increases in energy transmission loss of high frequency signals propagating through the waveguide 7a can be suppressed, it is possible to transmit high frequency signals from the slits 61 while maintaining a signal level in high frequency signals that have been input through waveguide input and output passages 8a and 8b of the waveguide structure 1A.

Moreover, in Embodiment 12, the slot array antenna 60 is explained as being configured using a waveguide structure 1A, but may also be configured using one of the other waveguide structures 1B through 1P.

### Embodiment 13

A high-performance vehicle radar apparatus can be achieved by using a waveguide structure 1A through 1P, or a slot array antenna 60, etc., in vehicle radar apparatuses that are mounted to an automotive vehicle such as an automobile, etc., for monitoring conditions in a vicinity of the automotive vehicle, and propagating electromagnetic waves that function as high frequency signals from the waveguide structure 1A through 1P or the slot array antenna 60, etc.

What is claimed is:

1. A wave guide structure comprising:
a base that has a mounting surface;
a metal plate member that has elasticity, that is stacked on said mounting surface, and that functions together with said base to constitute a waveguide;
a positioning mechanism that is constituted by:
a positioning member that is disposed so as to protrude from a first of said base and said plate member; and
an interfitting portion that is formed on a second of said base and said plate member, and that is fitted together with said positioning member,
said positioning mechanism positioning said plate member on said mounting surface of said base and also restricting movement along said mounting surface by fitting together of said positioning member and said interfitting portion; and
a holding means that holds said plate member in a state of close contact with said mounting surface by pressing said plate member so as to generate a reaction force in said plate member.

2. A waveguide structure according to claim 1, wherein:
said mounting surface is configured so as to have a curved surface that is obtained by sweeping in a sweep direction a deflection curve for a beam supported at two ends or for a cantilever; and
said plate member is stacked on said mounting surface so as to be elastically deformed along said mounting surface by a pressing force from said holding means.

3. A wave guide structure according to claim 1, wherein:
said mounting surface is configured so as to be flat; and
said plate member has front and rear surfaces that are configured so as to have curved surfaces that are obtained by sweeping in a sweep direction a deflection curve for a beam supported at two ends or for a cantilever, and is stacked on said mounting surface so as to be elastically deformed along said mounting surface by a pressing force from said holding means.

4. A waveguide structure according to claim 2, wherein said positioning mechanism is disposed on a portion of said mounting surface at which a distance from a plane that includes two edge portions of said mounting surface in a curve direction is at a maximum.

5. A waveguide structure according to claim 2, wherein said positioning mechanism is disposed on a portion of said mounting surface at which a gradient is gentlest.

6. A waveguide structure according to claim 2, wherein said positioning mechanism is disposed on a portion of said mounting surface near an edge portion in a curve direction.

7. A waveguide structure according to claim 1, wherein:
said positioning member is a single positioning pin that has an external shape other than a circle; and
said interfitting portion is an interfitting aperture that has an internal shape that matches said external shape of said positioning pin.

8. A waveguide structure according to claim 1, wherein:
said positioning member is a pair of first and second positioning pins that are separated from each other in said sweep direction; and
said interfitting portion is an interfitting aperture or a notch that has an internal shape that conforms to said external shape of said positioning pin that fits together therewith.

9. A waveguide structure according to claim 8, wherein a shape of a first interfitting portion is different than a shape of a second interfitting portion.

10. A waveguide structure according to claim 9, wherein:
an external shape of a first positioning pin is a circle;
said first interfitting portion is an interfitting aperture that has an internal shape that matches said external shape of said first positioning pin; and
said second interfitting portion is a slot-shaped interfitting aperture or a notch that has a major axis that is oriented in said sweep direction, and that has a minor axial length that corresponds to a length of said second positioning pin in said curve direction.

11. A waveguide structure according to claim 8, wherein an opening end corner portion of said notch is relieved.

12. A waveguide structure according to claim 8, wherein a floor portion of said notch has a rounded shape.

13. A waveguide structure according to claim 8, wherein said notch has a rectangular shape.

14. A waveguide structure according to claim 8, wherein said positioning pins are disposed on opposite sides of center in said sweep direction so as to be asymmetrical relative to said center in said sweep direction.

15. A waveguide structure according to claim 1, wherein said plate member is constituted by a plurality of divided plate members that are stacked on said mounting surface of said base.

16. A wave guide structure according to claim 7, wherein:
said positioning pin is disposed so as to project from said mounting surface;
said plate member is constituted by n divided plate members that are stacked on said mounting surface of said base, where n is an integer that is greater than or equal to 2;
n stacking sequence regulating pins that each have a height that corresponds to a respective number of stacked plates of said divided plate members from one plate to n plates are disposed so as to project from said mounting surface of said base so as to line up in a single column with said positioning pin in said sweep direction; and
stacking sequence regulating interfitting portions that fit together with stacking sequence regulating pins that have a height that corresponds to a respective number of stacked plates in said divided plate members from one plate to m plates are formed on a divided plate member that is stacked in an m-th layer on said mounting surface, where m is an integer that is greater than or equal to 1 and less than or equal to n.

17. A waveguide structure according to claim 16, wherein said positioning pins also function as said stacking sequence regulating pins that have a height that corresponds to n stacked plates of said divided plate members.

18. A waveguide structure according to claim 8, wherein:
said positioning pin is disposed so as to project from said mounting surface;
said plate member is constituted by n divided plate members that are stacked on said mounting surface of said base, where n is an integer that is greater than or equal to 2;
n stacking sequence regulating pins that each have a height that corresponds to a respective number of stacked plates of said divided plate members from one plate to n plates are disposed so as to project from said mounting surface of said base so as to line up in a single column with said positioning pin in said sweep direction; and
stacking sequence regulating interfitting portions that fit together with stacking sequence regulating pins that have a height that corresponds to a respective number of stacked plates in said divided plate members from one plate to m plates are formed on a divided plate member that is stacked in an m-th layer on said mounting surface, where m is an integer that is greater than or equal to 1 and less than or equal to n.

19. A waveguide structure according to claim 18, wherein said positioning pins also function as said stacking sequence regulating pins that have a height that corresponds to n stacked plates of said divided plate members.

20. A waveguide structure according to claim 7, wherein:
said positioning pin is disposed so as to project from said mounting surface;
said plate member is constituted by n divided plate members that are stacked on said mounting surface of said base, where n is an integer that is greater than or equal to 2;
a stacking sequence regulating member is disposed so as to project from said mounting surface so as to be separated from said positioning pin in said sweep direction such that first through (n−1)-th step portions in which area of a cross section that is perpendicular to a thickness direction is reduced sequentially are aligned in said thickness direction and configured integrally sequentially from first through (n−1)-th step portions, wherein an m-th step portion from said mounting surface has a height that corresponds to a respective number of stacked plates of said divided plate member from one plate to m plates, where m is an integer that is greater than or equal to 1 and less than or equal to n−1; and
a stacking sequence regulating interfitting portion that has a size that corresponds to a size of said cross-sectional area that is perpendicular to said thickness direction of said m-th step portion is formed on a divided plate member that is stacked on said mounting surface in an m-th layer.

21. A waveguide structure according to claim 20, wherein said stacking sequence regulating member is a multiple diameter pin in which first through (n−1)-th step portions that have circular cross sections in which a diameter is reduced sequentially are integrated coaxially.

22. A waveguide structure according to claim 8, wherein:
said positioning pin is disposed so as to project from said mounting surface;
said plate member is constituted by n divided plate members that are stacked on said mounting surface of said base, where n is an integer that is greater than or equal to 2;
a stacking sequence regulating member is disposed so as to project from said mounting surface so as to be separated from said positioning pin in said sweep direction such that first through (n−1)-th step portions in which area of a cross section that is perpendicular to a thickness direction is reduced sequentially are aligned in said thickness direction and configured integrally sequentially from first through (n−1)-th step portions, wherein an m-th step portion from said mounting surface has a height that corresponds to a respective number of stacked plates of said divided plate member from one plate to m plates, where m is an integer that is greater than or equal to 1 and less than or equal to n−1; and
a stacking sequence regulating intermitting portion that has a size that corresponds to a size of said cross-sectional area that is perpendicular to said thickness direction of said m-th step portion is formed on a divided plate member that is stacked on said mounting surface in an m-th layer.

23. A waveguide structure according to claim 22, wherein said stacking sequence regulating member is a multiple diameter pin in which first through (n−1)-th step portions that have circular cross sections in which a diameter is reduced sequentially are integrated coaxially.

24. A waveguide structure according to claim 7, wherein:
said positioning pin is disposed so as to project from said mounting surface;
said plate member is constituted by n divided plate members that are stacked on said mounting surface of said base, where n is an integer that is greater than or equal to 2;
a stacking sequence regulating member is disposed so as to project from said mounting surface so as to be separated from said positioning pin in said sweep direction such that first through n-th step portions in which area of a cross section that is perpendicular to a thickness direction is reduced sequentially are aligned in said thickness direction and configured integrally sequentially from first through n-th step portions, wherein an m-th step portion from said mounting surface has a height that corresponds to a respective number of stacked plates of said divided plate member from one plate to m plates, where m is an integer that is greater than or equal to 1 and less than or equal to n; and
a stacking sequence regulating interfitting portion that has a size that corresponds to a size of said cross-sectional area that is perpendicular to said thickness direction of said m-th step portion is formed on a divided plate member that is stacked on said mounting surface in an m-th layer.

25. A waveguide structure according to claim 24, wherein said stacking sequence regulating member is a multiple diameter pin in which first through n-th step portions that have circular cross sections in which a diameter is reduced sequentially are integrated coaxially.

26. A waveguide structure according to claim 24, wherein said stacking sequence regulating member also functions as said positioning pin.

27. A waveguide structure according to claim 8, wherein:
said positioning pin is disposed so as to project from said mounting surface;
said plate member is constituted by n divided plate members that are stacked on said mounting surface of said base, where n is an integer that is greater than or equal to 2;
a stacking sequence regulating member is disposed so as to project from said mounting surface so as to be separated from said positioning pin in said sweep direction such that first through n-th step portions in which area of a cross section that is perpendicular to a thickness direction is reduced sequentially are aligned in said thickness direction and configured integrally sequentially from first through n-th step portions, wherein an m-th step portion from said mounting surface has a height that corresponds to a respective number of stacked plates of said divided plate member from one plate to m plates, where m is an integer that is greater than or equal to 1 and less than or equal to n; and
a stacking sequence regulating interfitting portion that has a size that corresponds to a size of said cross-sectional area that is perpendicular to said thickness direction of said m-th step portion is formed on a divided plate member that is stacked on said mounting surface in an m-th layer.

28. A waveguide structure according to claim 27, wherein said stacking sequence regulating member is a multiple diameter pin in which first through n-th step portions that have circular cross sections in which a diameter is reduced sequentially are integrated coaxially.

29. A waveguide structure according to claim 27, wherein said stacking sequence regulating member also functions as said positioning pin.

30. An antenna apparatus that uses a waveguide structure according to claim 1, wherein said antenna apparatus has slits for high frequency signal emission that are formed so as to communicate between internal and external portions of said waveguide.

31. A vehicle radar apparatus that is configured using a waveguide structure according to claim 1.
